(19) United States
(12) Patent Application Publication
(10) Pub. No.: US 2023/0159678 A1
(43) Pub. Date: May 25, 2023

(54) METHODS OF POLYMERIZATION WITH AROMATIC THIOL INITIATORS

(71) Applicant: The Regents of the University of Colorado, a body corporate, Denver, CO (US)

(72) Inventors: Christopher N. Bowman, Boulder, CO (US); Dillon Love, Monroe, NC (US)

(21) Appl. No.: 18/011,106

(22) PCT Filed: Jun. 16, 2021
(86) PCT No.: PCT/US21/37611

§ 371 Date: Dec. 16, 2022

Related U.S. Application Data
(60) Provisional application No. 63/041,294, filed on Jun. 19, 2020.

(51) Int. Cl. C08F 120/38; C08F 120/12

(52) U.S. Cl. CPC C08F 120/38; C08F 120/12

(57) ABSTRACT

Provided herein are methods of using aryl thiols as photoinitiators. The thiol compounds are useful as oxygen insen-sitive photoinitiators for applications such as bulk polymerizations and for specialty polymer synthesis by preparing aromatic thiol functionalized macroinitiators.

### CROSS-REFERENCE TO RELATED APPLICATION

This application priority to U.S. Provisional Patent Application Ser. No. 63/041,294 entitled “METHODS OF POLYMERIZATION WITH AROMATIC THIOL INITIATORS,” filed Jun. 19, 2020, the disclosure of which is incorporated herein by reference in its entirety.

### STATEMENT REGARDING FEDERALLY SPONSORED RESEARCH

This invention was made with government support under grant numbers DMR1420736 and CHE1808484 awarded by the National Science Foundation. The government has certain rights in the invention.

### BACKGROUND

The radical-mediated thiol-ene coupling (TEC) reaction of a thiol and an alkene has become a robust and popular transformation in bio-conjugation, as well as in organic and materials synthesis, due to facile access to a wide range of useful, reactive functional groups. Under the appropriate implementation conditions, the TEC reaction has been designated as a “click” reaction, e.g., possessing quantitative and rapid kinetics, insensitivity to oxygen, water, and most organic functional groups, full atom economy, and high chemical- and regioselectivity. The reaction proceeds through a cyclic mechanism where in one step a thiyl radical, which is typically generated by exposure of a photoinitiator, propagates into the alkene to afford a secondary C-radical intermediate and C—S linkage. This C-radical intermediate then chain-transfers to another thiol via H-atom abstraction to regenerate the thiyl radical.

There is a need in the art for novel photoinitiators that can be used in homopolymerizations and/or TEC reactions. The present invention addresses this need.

### BRIEF SUMMARY OF THE INVENTION

In various embodiments, a method of polymerizing a substrate is provided. In certain embodiments, the method includes irradiating a composition comprising at least one substrate and a photoinitator,

wherein the at least one substrate comprises at least one polymerizable carbon-carbon double bond, and

wherein the photoinitiator comprises a compound of formula (I):

(Ar)ₙ—X—SH (I),

wherein:

Ar is optionally substituted C₆₋₁₈ aryl or optionally substituted C₆₋₁₈ heteroaryl, wherein the optional substitution is by 1 to 5 substituents independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;

X is a bond (absent) or C(═O) and n=1, or X is CH₃₋ₙ and n=1, 2, or 3; and

R at each occurrence is independently hydrogen, C₁-C₁₀ alkyl, or C₆₋₁₀ aryl; thereby forming an at least partially polymerized substrate.

In various embodiments, a composition is provided. In certain embodiments, the composition includes at least one substrate comprising at least one polymerizable carbon-carbon double bond; and

a photoinitator comprising a compound of formula (I):

(Ar)ₙ—X—SH (I),

wherein:

Ar is optionally substituted C₆₋₁₈ aryl or optionally substituted C₆₋₁₈ heteroaryl, wherein the optional substitution is by 1 to 5 substituents independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;

X is a bond (absent) or C(═O) and n=1, or X is CH₃₋ₙ and n=1, 2, or 3; and

R at each occurrence is independently hydrogen, C₁-C₁₀ alkyl, or C₆₋₁₀ aryl.

### BRIEF DESCRIPTION OF THE FIGURES

The drawings illustrate generally, by way of example, but not by way of limitation, various embodiments of the present application.

FIG. 1 shows qualitative representation of the diabatic potential energy surfaces for the ground state and two lowest energy excited states for aromatic molecules with an adjacent X—H bond (X═O, N, or S) along the X—H bond stretch coordinate.

FIG. 2 shows chemical structures and names of selected thiol photoinitiators.

FIGS. 3A-3D show UV/vis absorption spectra of thiols in DMSO at concentrations ranging from 0.1 to 100 mM. FIG. 3A shows comparative spectra for alkyl thiols vs. thiophenol. FIG. 3B shows comparative spectra for thioacids vs. thiophenol. FIG. 3C shows comparative spectra for nonheterocyclic aromatic thiols vs. thiophenol. FIG. 3D shows comparative spectra for heterocyclic aromatic thiols vs. thiophenol.

FIGS. 4A-4D show acrylate conversion profiles for the photopolymerization of HA (3 M) in DMSO with various thiols as photoinitiators (FIG. 4A) no thiol and T1-4, (FIG. 4B) T5 & T6, (FIG. 4C) T7-10, and (FIG. 4D) T11-13. Thiophenol T7 is included in each plot as a standard for comparison. Reactions were irradiated with 320-390 nm light with intensities of 10.0, 8.5, and 31 mW cm⁻² at 320 nm, 365 nm, and over all wavelengths combined, respectively.

FIGS. 5A-5B show acrylate conversion profiles for the photopolymerization of HA (3 M) in DMSO with various thiols as photoinitiators. FIG. 5A shows a comparison of kinetics for T7 initiated reactions with and without a CT agent versus the T9 initiated reaction without CT agent. FIG. 5B shows a comparison of kinetics for mercaptobenzoic acid initiated reactions versus thiophenol; reactions were formulated with 1 mol % thiol initiator (30 mM). All reactions were initiated with 320-390 nm light with intensities of 10.0, 8.5, and 31 mW cm⁻² at 320 nm, 365 nm, and over all wavelengths combined, respectively.

FIGS. 6A-6B show acrylate conversion profile as a function of irradiation time for the HA (3 M in DMSO) polymerization initiated by various thiols. FIG. 6A illustrates profiles shown correspond to the fastest kinetics afforded by each subclass of substituted thiophenol. Reactions were formulated with 1 mol % thiol (30 mM) and irradiated with 320-390 nm light nm. FIG. 6B shows conversion profiles for reactions initiated with T17 and T22, with 3 or 30 mM initiator concentration and variable irradiation wavelengths and intensities. Reactions with 320-390 nm light were irradiated at an intensity of 31 mW cm⁻², and reactions with 365 or 405 nm light were irradiated at an intensity of 10 mW cm⁻².

FIGS. 7A-7B show vinyl ether conversion profiles for the solventless photopolymerization of PETMP with 1,4-butanediol divinyl ether [SH]=[ene] using various thiols as photoinitiators, c=30 mM, and irradiating with either (FIG. 7A) 365 nm or (FIG. 7B) 405 nm light (10 mW cm²) to initiate reactions.

FIGS. 8A-8D show comparison of vinyl functional group conversion profiles as a function of irradiation time for the solventless reaction between thiols T1-3, T7, T20, and T20 and 1,4-butanediol divinyl ether. Reactions were irradiated with (FIG. 8A) 320-390 nm light with a total intensity of 31 mW cm⁻², (FIG. 8B) 320-390 nm light with a total intensity of 5 mW cm⁻², (FIG. 8C) 365 nm light with an intensity of 10 mW cm⁻², and (FIG. 8D) 405 nm light with an intensity of 10 mW cm⁻².

FIG. 9 shows hydrogel storage modulus as a function of irradiation time for the TEC polymerization between PEG2 MB and PEG2MP with PEG4NB. Polymerizations were formulated with 10 wt % PEG macromonomer [SH]=[Ene] in an aqueous solution of sodium phosphate monobasic pH 4.4. Reactions were irradiated with 320-390 nm (31 mW cm⁻²), 365 nm (10 mW cm⁻²), or 405 nm (10 mW cm⁻²) light.

FIGS. 10A-10B show GPC (gel permeation chromatography) traces of the polymerizations of (FIG. 10A) 1 and (FIG. 10B) 6 using aromatic thiols as initiators or CT (chain transfer) agents to prevent cyclization.

FIGS. 11A-11D show UV/vis spectrum of (FIG. 11A) mercaptobenzoic acid analogues, (FIG. 11B) (trifluoromethyl)thiophenol analogues, (FIG. 11C) methoxythiophenol analogues, and (FIG. 11D) aminothiophenol in DMSO.

FIGS. 12A-12B show the UV/vis spectrum of 2,2-dimethoxy-2-phenylacetophenone (DMPA) in DMSO at various concentrations (FIG. 12A). FIG. 12B illustrates a comparison of the UV/vis spectrums of DMPA and several substituted thiophenols derivative in DMSO at a concentration of 1 mM.

FIGS. 13A-13F show acrylate conversion profile as a function of irradiation time for the photopolymerization of HA (3 M in DMSO) with (FIG. 13A) T4, (FIG. 13B) T6, (FIG. 13C) T8, (FIG. 13D) T9, (FIG. 13E) T10, and (FIG. 13F) T11 as the photoinitiator. Reactions were irradiated with 320-390 nm light with intensities of 10.0, 8.5, and 31 mW cm⁻² at 320 nm, 365 nm, and over all wavelengths combined, respectively.

FIG. 14 shows acrylate conversion profile as a function of irradiation time for the photopolymerization of HA (n-hexyl acrylate) (3 M in DMSO) with thiophenol T7, thioanisole T27, and 2-(methylthio)benzoic acid T28 as the photoinitiator (30 mM). Reactions were irradiated with 320-390 nm light with intensities of 10.0, 8.5, and 31 mW cm⁻² at 320 nm, 365 nm, and over all wavelengths combined, respectively.

FIGS. 15A-15F show comparison of acrylate conversion profiles as a function of irradiation time for the photopolymerization of HA (3 M in DMSO) with (FIG. 15A) T6, (FIG. 15B) T9, (FIG. 15C) T10, (FIG. 15D) T20, (FIG. 15E) T24, and (FIG. 15F) T25 as the photoinitiator and with or without T1 present as a CT agent. Reactions were irradiated with 320-390 nm light with intensities of 10.0, 8.5, and 31 mW cm⁻² at 320 nm, 365 nm, and over all wavelengths combined, respectively.

FIGS. 16A-16B show a comparison of acrylate conversion profiles as a function of irradiation time for the photopolymerization of HA (3M in DMSO) with (FIG. 16A) T7, T19, T20, and T21 (FIG. 16B) T7, T22, T23, and T24 as the photoinitiator (30 mM).

FIG. 17 shows acrylate conversion profiles as a function of irradiation time for the HA (3 M in DMSO) polymerization initiated by DMPA or T17 (1 wt %). Reactions were irradiated with 365 nm or 405 nm light at an intensity of 10 mW cm⁻².

FIG. 18 shows vinyl ether conversion profiles for the solventless photopolymerization of PETM with 1,4-butanediol divinyl ether [SH]=[ene] using mercaptobenzoic acid derivatives as PIs in TEC network polymerizations. Reactions were irradiated with 405 nm light at an intensity of 10 mW cm⁻².

FIG. 19 shows FTIR absorbance spectra of the polymerization of n-hexyl acrylate (3M in DMSO) using 1 mol % 2-mercaptobenzoic acid (T9) as the photoinitiator. The reaction was irradiated with 365 nm light (10 mW cm⁻²) and spectra correspond to 0, 40, and 120 s of irradiation.

FIG. 20 shows H¹ NMR spectra of the polymerization of n-hexyl acrylate (3M in DMSO) using 1 mol % 2-mercaptobenzoic acid (T9) as the photoinitiator. The reaction was irradiated with 365 nm light (10 mW cm⁻²) for 10 minutes.

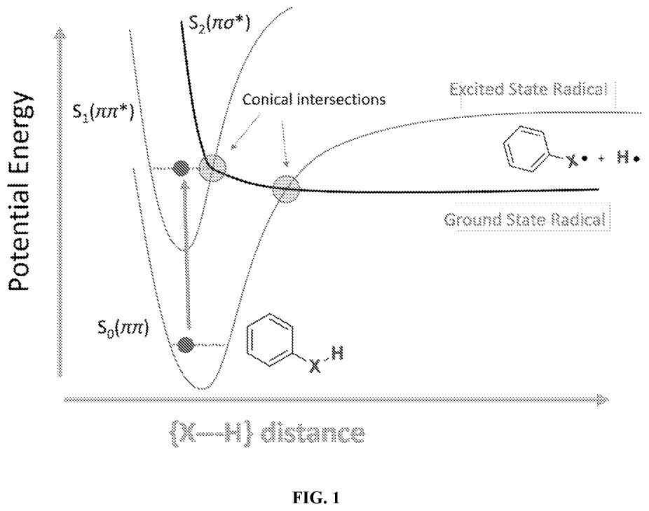

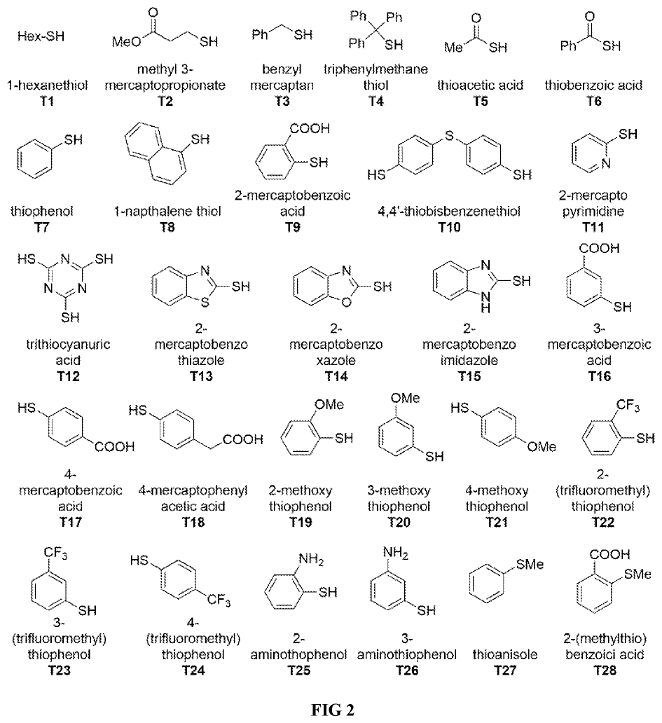

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” or “at least one of A or B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section. All publications, patents, and patent documents referred to in this document are incorporated by reference herein in their entirety, as though individually incorporated by reference.

In the methods described herein, the acts can be carried out in any order, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

### Definitions

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that the composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less. The term “substantially free of” can mean having a trivial amount of, such that a composition is about 0 wt % to about 5 wt % of the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

The term “organic group” as used herein refers to any carbon-containing functional group. Examples can include an oxygen-containing group such as an alkoxy group, aryloxy group, aralkyloxy group, oxo(carbonyl) group; a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R can be hydrogen (in examples that include other carbon atoms) or a carbon-based moiety, and wherein the carbon-based moiety can be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “alkenyl” as used herein refers to straight and branched chain and cyclic alkyl groups as defined herein, except that at least one double bond exists between two carbon atoms. Thus, alkenyl groups have from 2 to 40 carbon atoms, or 2 to about 20 carbon atoms, or 2 to 12 carbon atoms or, in some embodiments, from 2 to 8 carbon atoms. Examples include, but are not limited to vinyl, —CH═C═CCH₂, —CH═CH(CH₃), —CH═C(CH₃)₂, —C(CH₃)═CH₂, —C(CH₃)═CH(CH₃), —C(CH₂CH₃)═CH₂, cyclohexenyl, cyclopentenyl, cyclohexadienyl, butadienyl, pentadienyl, and hexadienyl among others.

The term “alkynyl” as used herein refers to straight and branched chain alkyl groups, except that at least one triple bond exists between two carbon atoms. Thus, alkynyl groups have from 2 to 40 carbon atoms, 2 to about 20 carbon atoms, or from 2 to 12 carbons or, in some embodiments, from 2 to 8 carbon atoms. Examples include, but are not limited to —C≡CH, —C≡C(CH₃), —C≡C(CH₂CH₃), —CH₂C≡CH, —CH₂C≡C(CH₃), and —CH₂C≡C(CH₂CH₃) among others.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4-2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

The term “heterocyclyl” as used herein refers to aromatic and non-aromatic ring compounds containing three or more ring members, of which one or more is a heteroatom such as, but not limited to, N, O, and S. Thus, a heterocyclyl can be a cycloheteroalkyl, or a heteroaryl, or if polycyclic, any combination thereof. In some embodiments, heterocyclyl groups include 3 to about 20 ring members, whereas other such groups have 3 to about 15 ring members. A heterocyclyl group designated as a C₂-heterocyclyl can be a 5-ring with two carbon atoms and three heteroatoms, a 6-ring with two carbon atoms and four heteroatoms and so forth. Likewise a C₄-heterocyclyl can be a 5-ring with one heteroatom, a 6-ring with two heteroatoms, and so forth. The number of carbon atoms plus the number of heteroatoms equals the total number of ring atoms. A heterocyclyl ring can also include one or more double bonds. A heteroaryl ring is an embodiment of a heterocyclyl group. The phrase “heterocyclyl group” includes fused ring species including those that include fused aromatic and non-aromatic groups. For example, a dioxolanyl ring and a benzdioxolanyl ring system (methylenedioxyphenyl ring system) are both heterocyclyl groups within the meaning herein. The phrase also includes polycyclic ring systems containing a heteroatom such as, but not limited to, quinuclidyl. Heterocyclyl groups can be unsubstituted, or can be substituted as discussed herein. Heterocyclyl groups include, but are not limited to, pyrrolidinyl, piperidinyl, piperazinyl, morpholinyl, pyrrolyl, pyrazolyl, triazolyl, tetrazolyl, oxazolyl, isoxazolyl, thiazolyl, pyridinyl, thiophenyl, benzothiophenyl, benzofuranyl, dihydrobenzofuranyl, indolyl, dihydroindolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Representative substituted heterocyclyl groups can be mono-substituted or substituted more than once, such as, but not limited to, piperidinyl or quinolinyl groups, which are 2-, 3-, 4-, 5-, or 6-substituted, or disubstituted with groups such as those listed herein.

The term “heteroaryl” as used herein refers to aromatic ring compounds containing 5 or more ring members, of which, one or more is a heteroatom such as, but not limited to, N, O, and S; for instance, heteroaryl rings can have 5 to about 8-12 ring members. A heteroaryl group is a variety of a heterocyclyl group that possesses an aromatic electronic structure. A heteroaryl group designated as a C₂-heteroaryl can be a 5-ring with two carbon atoms and three heteroatoms, a 6-ring with two carbon atoms and four heteroatoms and so forth. Likewise a C₄-heteroaryl can be a 5-ring with one heteroatom, a 6-ring with two heteroatoms, and so forth. The number of carbon atoms plus the number of heteroatoms sums up to equal the total number of ring atoms. Heteroaryl groups include, but are not limited to, groups such as pyrrolyl, pyrazolyl, triazolyl, tetrazolyl, oxazolyl, isoxazolyl, thiazolyl, pyridinyl, thiophenyl, benzothiophenyl, benzofuranyl, indolyl, azaindolyl, indazolyl, benzimidazolyl, azabenzimidazolyl, benzoxazolyl, benzothiazolyl, benzothiadiazolyl, imidazopyridinyl, isoxazolopyridinyl, thianaphthalenyl, purinyl, xanthinyl, adeninyl, guaninyl, quinolinyl, isoquinolinyl, tetrahydroquinolinyl, quinoxalinyl, and quinazolinyl groups. Heteroaryl groups can be unsubstituted, or can be substituted with groups as is discussed herein. Representative substituted heteroaryl groups can be substituted one or more times with groups such as those listed herein.

Additional examples of aryl and heteroaryl groups include but are not limited to phenyl, biphenyl, indenyl, naphthyl (1-naphthyl, 2-naphthyl), N-hydroxytetrazolyl, N-hydroxytriazolyl, N-hydroxyimidazolyl, anthracenyl (1-anthracenyl, 2-anthracenyl, 3-anthracenyl), thiophenyl (2-thienyl, 3-thienyl), furyl (2-furyl, 3-furyl), indolyl, oxadiazolyl, isoxazolyl, quinazolinyl, fluorenyl, xanthenyl, isoindanyl, benzhydryl, acridinyl, thiazolyl, pyrrolyl (2-pyrrolyl), pyrazolyl (3-pyrazolyl), imidazolyl (1-imidazolyl, 2-imidazolyl, 4-imidazolyl, 5-imidazolyl), triazolyl (1,2,3-triazol-1-yl, 1,2,3-triazol-2-yl 1,2,3-triazol-4-yl, 1,2,4-triazol-3-yl), oxazolyl (2-oxazolyl, 4-oxazolyl, 5-oxazolyl), thiazolyl (2-thiazolyl, 4-thiazolyl, 5-thiazolyl), pyridyl (2-pyridyl, 3-pyridyl, 4-pyridyl), pyrimidinyl (2-pyrimidinyl, 4-pyrimidinyl, 5-pyrimidinyl, 6-pyrimidinyl), pyrazinyl, pyridazinyl (3-pyridazinyl, 4-pyridazinyl, 5-pyridazinyl), quinolyl (2-quinolyl, 3-quinolyl, 4-quinolyl, 5-quinolyl, 6-quinolyl, 7-quinolyl, 8-quinolyl), isoquinolyl (1-isoquinolyl, 3-isoquinolyl, 4-isoquinolyl, 5-isoquinolyl, 6-isoquinolyl, 7-isoquinolyl, 8-isoquinolyl), benzo[b]furanyl (2-benzo[b]furanyl, 3-benzo[b]furanyl, 4-benzo[b]furanyl, 5-benzo[b]furanyl, 6-benzo[b]furanyl, 7-benzo[b]furanyl), 2,3-dihydro-benzo[b]furanyl (2-(2,3-dihydro-benzo[b]furanyl), 3-(2,3-dihydro-benzo[b]furanyl), 4-(2,3-dihydro-benzo[b]furanyl), 5-(2,3-dihydro-benzo[b]furanyl), 6-(2,3-dihydro-benzo[b]furanyl), 7-(2,3-dihydro-benzo[b]furanyl), benzo[b]thiophenyl (2-benzo[b]thiophenyl, 3-benzo[b]thiophenyl, 4-benzo[b]thiophenyl, 5-benzo[b]thiophenyl, 6-benzo[b]thiophenyl, 7-benzo[b]thiophenyl), 2,3-dihydro-benzo[b]thiophenyl, (2-(2,3-dihydro-benzo[b]thiophenyl), 3-(2,3-dihydro-benzo[b]thiophenyl), 4-(2,3-dihydro-benzo[b]thiophenyl), 5-(2,3-dihydro-benzo[b]thiophenyl), 6-(2,3-dihydro-benzo[b]thiophenyl), 7-(2,3-dihydro-benzo[b]thiophenyl), indolyl (1-indolyl, 2-indolyl, 3-indolyl, 4-indolyl, 5-indolyl, 6-indolyl, 7-indolyl), indazole (1-indazolyl, 3-indazolyl, 4-indazolyl, 5-indazolyl, 6-indazolyl, 7-indazolyl), benzimidazolyl (1-benzimidazolyl, 2-benzimidazolyl, 4-benzimidazolyl, 5-benzimidazolyl, 6-benzimidazolyl, 7-benzimidazolyl, 8-benzimidazolyl), benzoxazolyl (1-benzoxazolyl, 2-benzoxazolyl), benzothiazolyl (1-benzothiazolyl, 2-benzothiazolyl, 4-benzothiazolyl, 5-benzothiazolyl, 6-benzothiazolyl, 7-benzothiazolyl), carbazolyl (1-carbazolyl, 2-carbazolyl, 3-carbazolyl, 4-carbazolyl), 5H-dibenz[b,f]azepine (5H-dibenz[b,f]azepin-1-yl, 5H-dibenz[b,f]azepine-2-yl, 5H-dibenz[b,f]azepine-3-yl, 5H-dibenz[b,f]azepine-4-yl, 5H-dibenz[b,f]azepine-5-yl), 10,11-dihydro-5H-dibenz[b,f]azepine (10,11-dihydro-5H-dibenz[b,f]azepine-1-yl, 10,11-dihydro-5H-dibenz[b,f]azepine-2-yl, 10,11-dihydro-5H-dibenz[b,f]azepine-3-yl, 10,11-dihydro-5H-dibenz[b,f]azepine-4-yl, 10,11-dihydro-5H-dibenz[b,f]azepine-5-yl), and the like.

The term “heterocyclylalkyl” as used herein refers to alkyl groups as defined herein in which a hydrogen or carbon bond of an alkyl group as defined herein is replaced with a bond to a heterocyclyl group as defined herein. Representative heterocyclyl alkyl groups include, but are not limited to, furan-2-yl methyl, furan-3-yl methyl, pyridine-3-yl methyl, tetrahydrofuran-2-yl ethyl, and indol-2-yl propyl.

The term “heteroarylalkyl” as used herein refers to alkyl groups as defined herein in which a hydrogen or carbon bond of an alkyl group is replaced with a bond to a heteroaryl group as defined herein.

The term “alkoxy” as used herein refers to an oxygen atom connected to an alkyl group, including a cycloalkyl group, as are defined herein. Examples of linear alkoxy groups include but are not limited to methoxy, ethoxy, propoxy, butoxy, pentyloxy, hexyloxy, and the like. Examples of branched alkoxy include but are not limited to isopropoxy, sec-butoxy, tert-butoxy, isopentyloxy, isohexyloxy, and the like. Examples of cyclic alkoxy include but are not limited to cyclopropyloxy, cyclobutyloxy, cyclopentyloxy, cyclohexyloxy, and the like. An alkoxy group can include about 1 to about 12, about 1 to about 20, or about 1 to about 40 carbon atoms bonded to the oxygen atom, and can further include double or triple bonds, and can also include heteroatoms. For example, an allyloxy group or a methoxyethoxy group is also an alkoxy group within the meaning herein, as is a methylenedioxy group in a context where two adjacent atoms of a structure are substituted therewith.

The term “amine” as used herein refers to primary, secondary, and tertiary amines having, e.g., the formula N(group)₃ wherein each group can independently be H or non-H, such as alkyl, aryl, and the like. Amines include but are not limited to R—NH₂, for example, alkylamines, arylamines, alkylarylamines; R₂NH wherein each R is independently selected, such as dialkylamines, diarylamines, aralkylamines, heterocyclylamines and the like; and R₃N wherein each R is independently selected, such as trialkylamines, dialkylarylamines, alkyldiarylamines, triarylamines, and the like. The term “amine” also includes ammonium ions as used herein.

The term “amino group” as used herein refers to a substituent of the form —NH₂, —NHR, —NR₂, —NR₃⁺, wherein each R is independently selected, and protonated forms of each, except for —NR₃⁺, which cannot be protonated. Accordingly, any compound substituted with an amino group can be viewed as an amine. An “amino group” within the meaning herein can be a primary, secondary, tertiary, or quaternary amino group. An “alkylamino” group includes a monoalkylamino, dialkylamino, and trialkylamino group.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms can be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The terms “epoxy-functional” or “epoxy-substituted” as used herein refers to a functional group in which an oxygen atom, the epoxy substituent, is directly attached to two adjacent carbon atoms of a carbon chain or ring system. Examples of epoxy-substituted functional groups include, but are not limited to, 2,3-epoxypropyl, 3,4-epoxybutyl, 4,5-epoxypentyl, 2,3-epoxypropoxy, epoxypropoxypropyl, 2-glycidoxyethyl, 3-glycidoxypropyl, 4-glycidoxybutyl, 2-(glycidoxycarbonyl)propyl, 3-(3,4-epoxycylohexyl)propyl, 2-(3,4-epoxycyclohexyl)ethyl, 2-(2,3-epoxycylopentyl)ethyl, 2-(4-methyl-3,4-epoxy cyclohexyl)propyl, 2-(3,4-epoxy-3-methylcylohexyl)-2-methylethyl, and 5,6-epoxyhexyl.

The term “monovalent” as used herein refers to a substituent connecting via a single bond to a substituted molecule. When a substituent is monovalent, such as, for example, F or Cl, it is bonded to the atom it is substituting by a single bond.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The term “solvent” as used herein refers to a liquid that can dissolve a solid, liquid, or gas. Non-limiting examples of solvents are silicones, organic compounds, water, alcohols, ionic liquids, and supercritical fluids.

The term “independently selected from” as used herein refers to referenced groups being the same, different, or a mixture thereof, unless the context clearly indicates otherwise. Thus, under this definition, the phrase “X¹, X², and X³ are independently selected from noble gases” would include the scenario where, for example, X¹, X², and X³ are all the same, where X¹, X², and X³ are all different, where X¹ and X² are the same but X³ is different, and other analogous permutations.

The term “room temperature” as used herein refers to a temperature of about 15° C. to 28° C.

The term “standard temperature and pressure” as used herein refers to 20° C. and 101 kPa.

Methods of Polymerizing with Aryl Thiol Photoinitiators

In certain embodiments, a method of polymerizing a substrate is provided. The method includes irradiating a composition comprising at least one substrate and a photoinitator, wherein the substrate comprises at least one polymerable carbon-carbon double bond, e.g., at least one polymerizable alkenyl group, and wherein the photoinitiator comprises a compound of formula (I):

(Ar)ₙ—X—SH (I),

wherein:

Ar is optionally substituted C₆₋₁₈ aryl or optionally substituted C₆₋₁₈ heteroaryl, wherein the optional substitution is by 1 to 5 substituents independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;

X is a bond (absent) or C(═O) and n=1, or X is CH₃₋ₙ and n=1, 2, or 3; and

R at each occurrence is independently hydrogen, C₁-C₁₀ alkyl, or C₆₋₁₀ aryl; forming a polymerized substrate.

In various embodiments, n is 1. In some embodiments, X is a bond.

In one embodiment, Ar is an optionally substituted C₆₋₁₀ aryl or C₆₋₁₀ aryl wherein at least one substituent is selected from the group consisting of CF₃, COOH, NH₂, OMe, and CH₂COOH.

In one embodiment, the photoinitiator is selected from the group consisting of

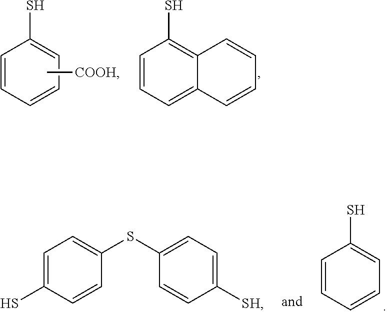

In various embodiments, the photoinitiator is selected from the group consisting of:

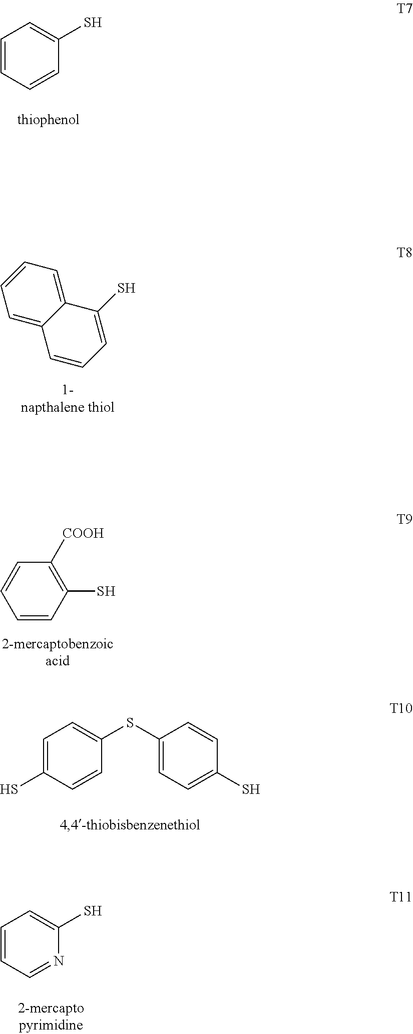 [SMILES: Sc1ccccc1 ; Sc1cccc2ccccc12 ; O=C(O)c1ccccc1S ; Sc1ccc(Sc2ccc(S)cc2)cc1 ; Sc1ccccn1]

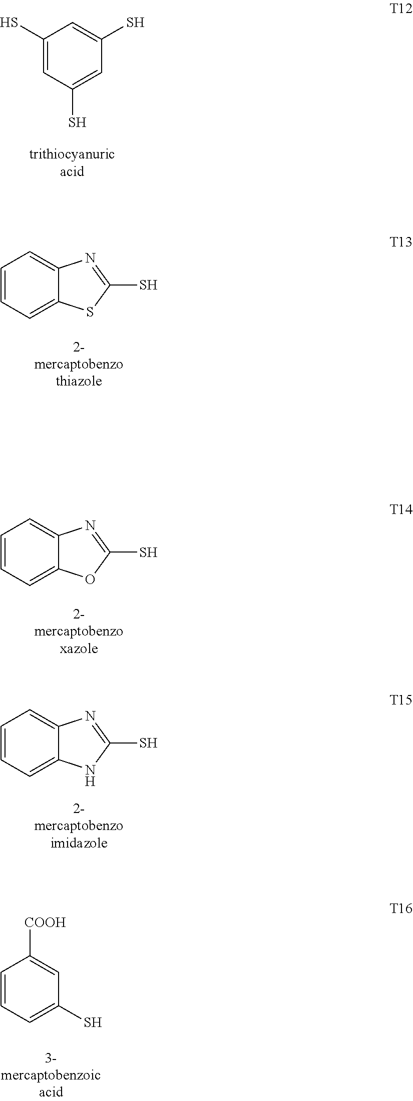 [SMILES: Sc1cc(S)cc(S)c1 ; Sc1nc2ccccc2s1 ; Sc1nc2ccccc2o1 ; Sc1nc2ccccc2[nH]1 ; O=C(O)c1cccc(S)c1]

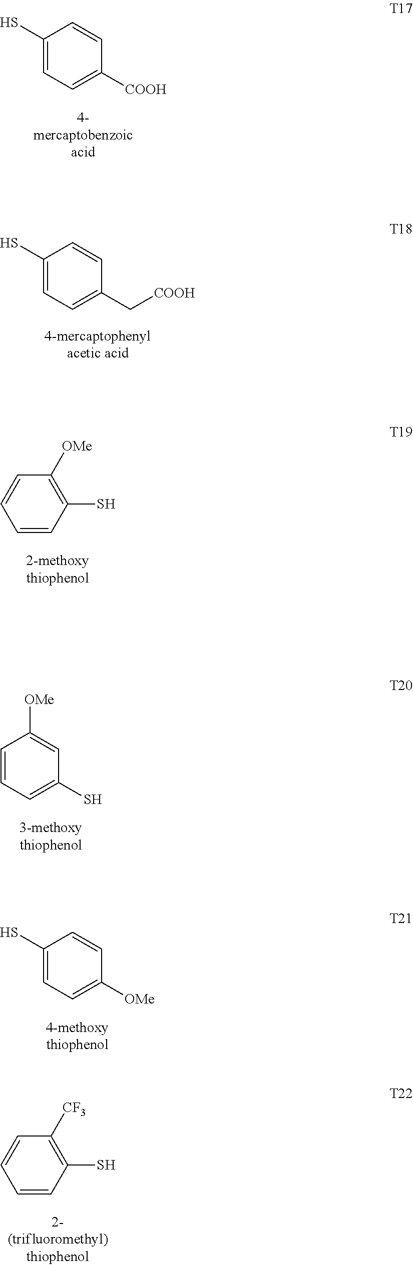 [SMILES: O=C(O)c1ccc(S)cc1 ; O=C(O)Cc1ccc(S)cc1 ; COc1ccccc1S ; COc1cccc(S)c1 ; COc1ccc(S)cc1 ; FC(F)(F)c1ccccc1S]

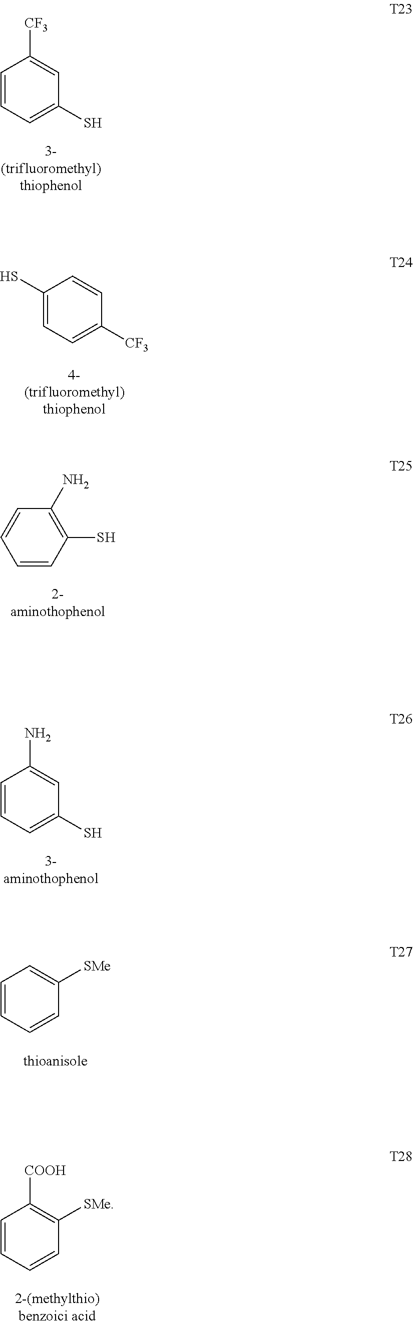 [SMILES: FC(F)(F)c1cccc(S)c1 ; FC(F)(F)c1ccc(S)cc1 ; Nc1ccccc1S ; Nc1cccc(S)c1 ; CSc1ccccc1 ; CSc1ccccc1C(=O)O]

In various embodiments, the photoinitiator is not compound T7. In various embodiments, the photoinitiator is not compound T8. In various embodiments, the photoinitiator is not compound T9. In various embodiments, the photoinitiator is not compound T10. In various embodiments, the photoinitiator is not compound T11. In various embodiments, the photoinitiator is not compound T12. In various embodiments, the photoinitiator is not compound T13. In various embodiments, the photoinitiator is not compound T14. In various embodiments, the photoinitiator is not compound T15. In various embodiments, the photoinitiator is not compound T16. In various embodiments, the photoinitiator is not compound T17. In various embodiments, the photoinitiator is not compound T18. In various embodiments, the photoinitiator is not compound T19. In various embodiments, the photoinitiator is not compound T20. In various embodiments, the photoinitiator is not compound T21. In various embodiments, the photoinitiator is not compound T22. In various embodiments, the photoinitiator is not compound T23. In various embodiments, the photoinitiator is not compound T24. In various embodiments, the photoinitiator is not compound T25. In various embodiments, the photoinitiator is not compound T26. In various embodiments, the photoinitiator is not compound T27. In various embodiments, the photoinitiator is not compound T28.

In various embodiments, the photoinitiator is not

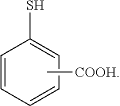

In various embodiments, the photoinitiator is not

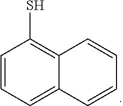 [SMILES: Sc1cccc2ccccc12]

In various embodiments, the photoinitiator is not

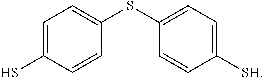 [SMILES: Sc1ccc(Sc2ccc(S)cc2)cc1]

In various embodiments, the photoinitiator is not

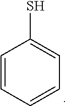

In various embodiments, the substrate having at least one polymerable carbon-carbon double bond has the structure:

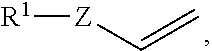

wherein:
Z is —O—, —CH₂—, —C(═O)—, —CH₂O—, —OCH₂—, —CH₂CH₂—, —CH₂C(═O)—, —C(═O)CH₂—, —OC(═O)—, —C(═O)O—, —N(R)CH₂—, —CH₂N(R)—, —C(═O)N(R)—; or —N(R)C(═O)—;
wherein R¹ is selected from the group consisting of C₁₋₂₀ alkyl, C₂₋₂₀ alkenyl, C₂₋₂₀ alkynyl C₁₋₂₀ heteroalkyl, C₃₋₂₀ cycloalkyl, C₃₋₂₀ heterocycloalkyl, C₁₋₂₀ alkyl-C₆₋₁₄ aryl, C₁₋₂₀ alkyl-C₆₋₁₄ heteroaryl, C₁₋₂₀ heteroalkyl-C₆₋₁₄ aryl, C₁₋₂₀ heteroalkyl-C₆₋₁₄ heteroaryl each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;
wherein each occurrence of R is independently hydrogen, C₁-C₁₀ alkyl, or C₆₋₁₀ aryl.

In various embodiments, the substrate includes at least one thiol-containing monomer and at least one terminal alkene-containing monomer. In various embodiment, the thiol-containing monomer contains 2 to 6 thiol (SH) groups. In various embodiments, the alkene-containing monomer contains 2 terminal alkenes.

In various embodiments, the thiol-containing monomer is selected from the group consisting of

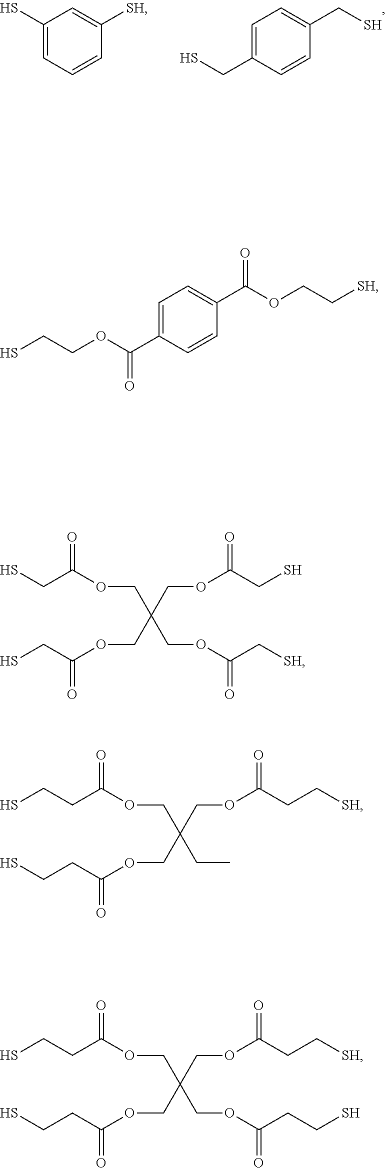 [SMILES: Sc1cccc(S)c1 ; SCc1ccc(CS)cc1 ; O=C(OCCS)c1ccc(C(=O)OCCS)cc1 ; O=C(CS)OCC(COC(=O)CS)(COC(=O)CS)COC(=O)CS ; CCC(COC(=O)CCS)(COC(=O)CCS)COC(=O)CCS ; O=C(CCS)OCC(COC(=O)CCS)(COC(=O)CCS)COC(=O)CCS]

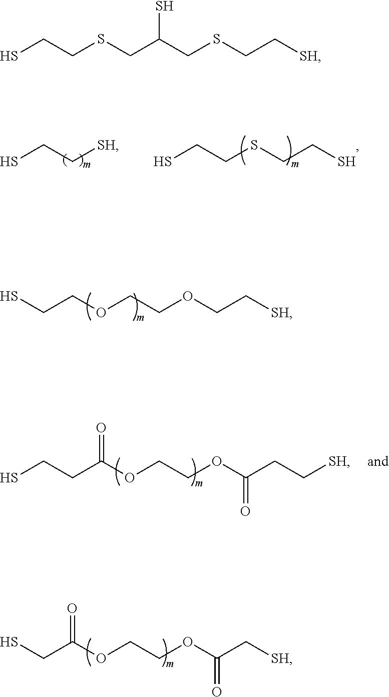

wherein each instance of m is independently an integer from 1 to 25.

In certain embodiments the alkene-containing monomer is selected from the group consisting of

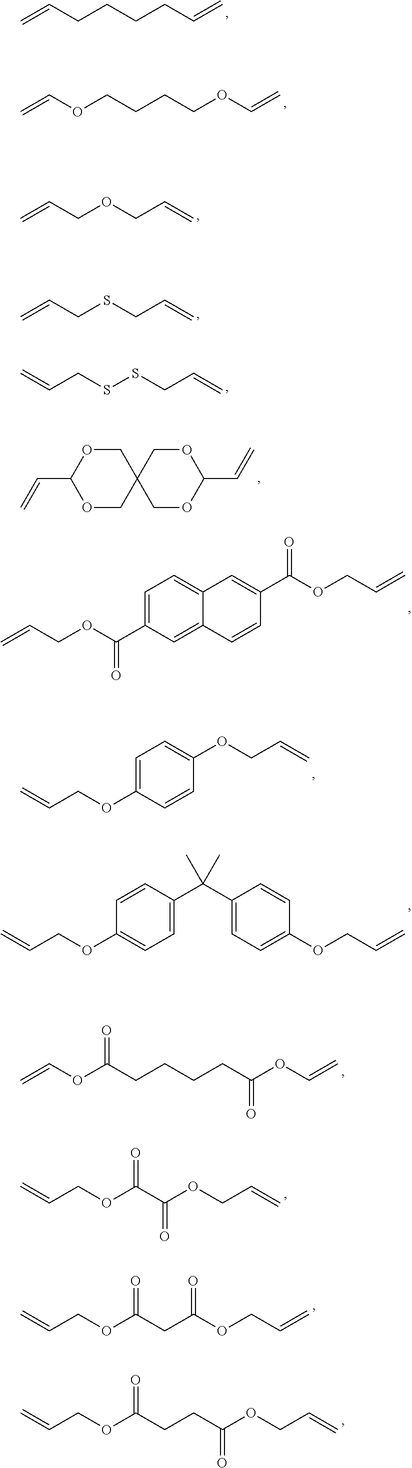

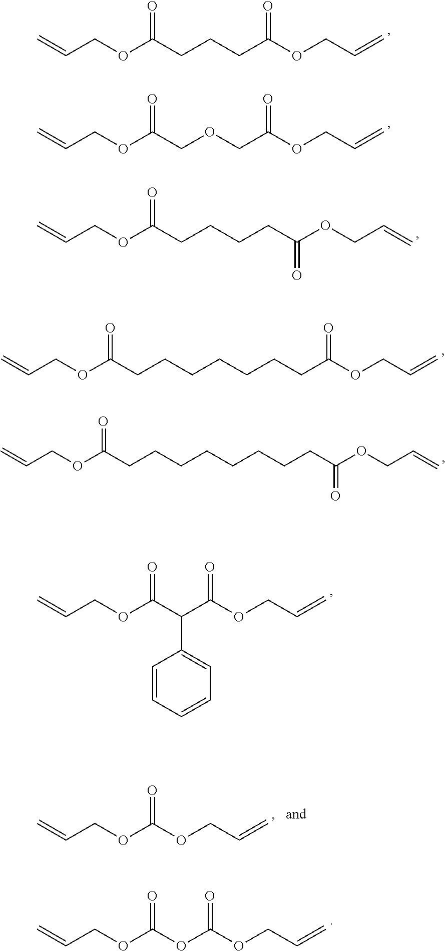

In various embodiments, the composition is irradiated with UV radiation having wavelength of about 300 nm to about 410 nm. In various embodiments, the composition is irradiated with UV radiation having wavelength of about 300, 305, 310, 315, 320, 325, 330, 335, 340, 345, 350, 355, 360, 365, 370, 375, 380, 385, 390, 395, 400, 405, or about 410 nm. In various embodiments, the UV radiation has a wavelength about 320 to about 390 nm.

In certain embodiments, the irradiation comprises UV light having intensity of about 1 mW/cm² to about 50 mW/cm². In certain embodiments, the UV light has an intensity of about 1, 2, 3, 4, 5, 6, 7, 8, 9, 10, 15, 20, 25, 30, 35, 40, 45, or about 50 mW/cm².

The amount of photoinitator used in the methods herein can be from about 0.01 to about 10 mol % relative to the amount of a substrate. In various embodiments, the amount of photoinitiator used can be about 0.01, 0.02, 0.03, 0.04, 0.05, 0.06, 0.07, 0.08. 0.09, 0.1, 0.2, 0.3, 0.4, 0.5, 0.6, 0.7, 0.8, 0.9, 1, 2, 3, 4, 5, 6, 7, 8, 9, or 10 mol %.

Also provided is a composition including at least one substrate comprising at least one carbon-carbon double bond and a photoinitator comprising a compound of formula (I).

(Ar)ₙ—X—SH (I),

wherein Ar, n, and x are as defined herein.

In various embodiments, the photoinitiator has the structure of any one of compounds T7 to T28. The UV/vis absorptivity for thiols T1-T28 is summarized in Table 1.

TABLE 1
UV/vis absorptivity of thiols in DMSO^{a}

| | | λ of max | ε₂₆₀ | ε₃₀₀ | ε₃₂₀ | ε₃₆₅ | ε₄₀₀ |
|---|---|---|---|---|---|---|---|
| | Concentration | absorption | (cm² | (cm² | (cm² | (c² | (cm² |
| Thiol | (mM) | (nm) | mol⁻¹) | mol⁻¹) | mol⁻¹) | mol⁻¹) | mol⁻¹) |
| T1 | 100 | 260 | 11 | 1 | X | X | X |
| T2 | 100 | 263 | 31 | 28 | 3 | X | X |
| T3 | 100 | 267 | 32 | 22 | 8 | 2 | X |
| T4 | 100 | X | X | X | X | X | X |
| T5 | 1 | 272 | 1,400 | 53 | 26 | 45 | X |
| T6 | 0.1 | 294 | 19,000 | 32,000 | 21,000 | 270 | 340 |
| T7 | 1 | 278 | 3,300 | 2,300 | 530 | 206 | X |
| T8 | 1 | 324 | 0 | 780 | 760 | 140 | 63 |
| T9 | 1 | 315 | 920 | 2,200 | 2,100 | 310 | 110 |
| T10 | 1 | 296 | 0 | 1,607 | 1,300 | 200 | 0 |
| T11 | 1 | 288 | 1,600 | 3,900 | 1,200 | 2,300 | 1,900 |
| T12 | 1 | 302 | 1,900 | 3,800 | 3,700 | 370 | 57 |
| T13 | 1 | 321 | 450 | 2,000 | 2,100 | 190 | 110 |
| T14 | 1 | 296 | 2,000 | 3,700 | 1,800 | 0 | 0 |
| T15 | 1 | 312 | 1,700 | 3,500 | 3,300 | 0 | 0 |
| T16 | 1 | 262 | 2,000 | 1,400 | 930 | 0 | 0 |
| T17 | 1 | 283 | 2,000 | 2,600 | 180 | 350 | 31 |
| T18 | 1 | 262 | 1,800 | 280 | 120 | 18 | 0 |
| T19 | 1 | 292 | 1,200 | 1,200 | 97 | 0 | 0 |
| T20 | 1 | 292 | 1,200 | 530 | 93 | 0 | 0 |
| T21 | 1 | 295 | 1,100 | 1,700 | 180 | 0 | 0 |
| T22 | 1 | 288 | 1,800 | 2,500 | 430 | 86 | 0 |
| T23 | 1 | 289 | 1,300 | 1,300 | 310 | 28 | 0 |
| T24 | 1 | 272 | 1,200 | 400 | 540 | 95 | 62 |
| T25 | 1 | 305 | 1,500 | 1,200 | 720 | 130 | 30 |
| T25(H)^{+b} | 1 | 299 | 850 | 2,200 | 2,100 | 1,100 | 320 |
| T26 | 1 | 307 | 2,100 | 2,500 | 1,500 | 590 | 0 |
| T26(H)⁺ | 1 | 307 | 1,300 | 2,200 | 1,400 | 880 | 0 |
| T27 | 1 | 268 | 2,000 | 230 | 0 | 0 | 0 |
| T28 | 1 | 271 | 1,700 | 720 | 900 | 0 | 0 |

^{a}UV/vis absorption spectrums were recorded at concentrations between 100 mM and 0.1 mM, and molar attenuation coefficients ε were calculated according to Beer's Law, A = εcl; where A is absorbance, c is concentration, and l is the path length (1 cm).
^{b}Amino thiophenol derivatives, T25 and T26, were protonated with 1 equivalent of acetic acid to afford the protonated T25(H)+ and T26(H)+ species.
Neutral acetic acid in DMSO has no absorbance in the wavelengths observed.

The structures of thiols T1-T28 are shown below.

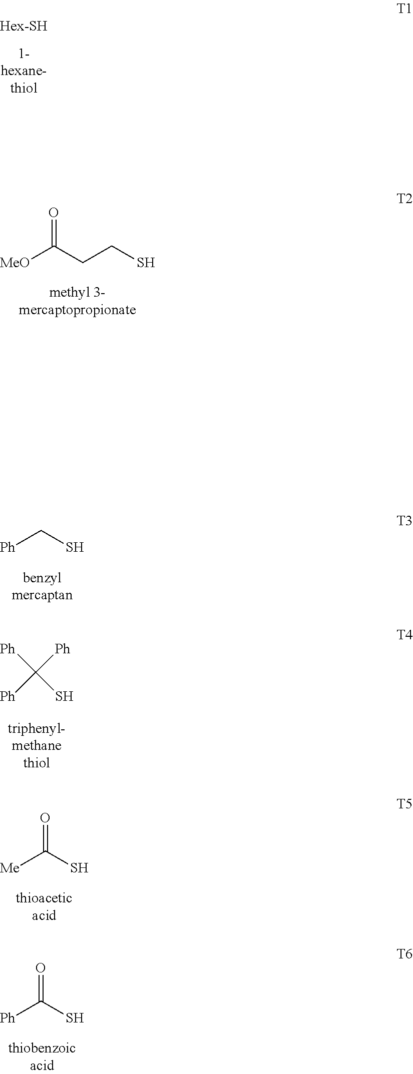

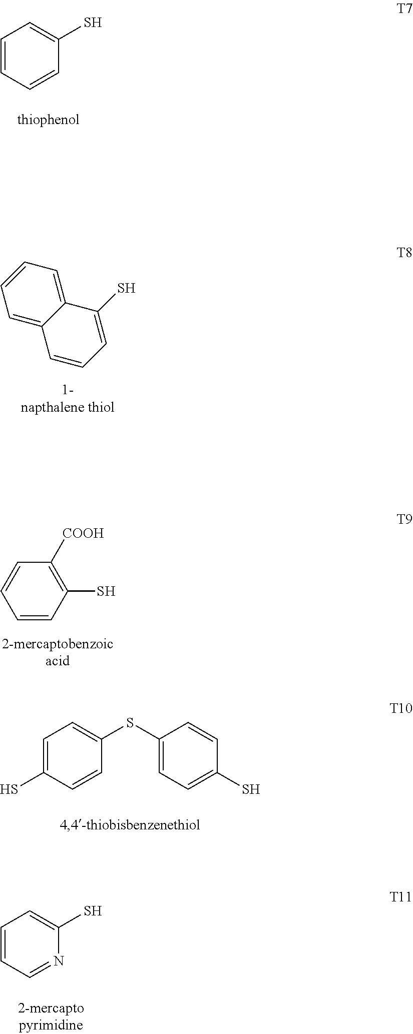 [SMILES: Sc1ccccc1 ; Sc1cccc2ccccc12 ; O=C(O)c1ccccc1S ; Sc1ccc(Sc2ccc(S)cc2)cc1 ; Sc1ccccn1]

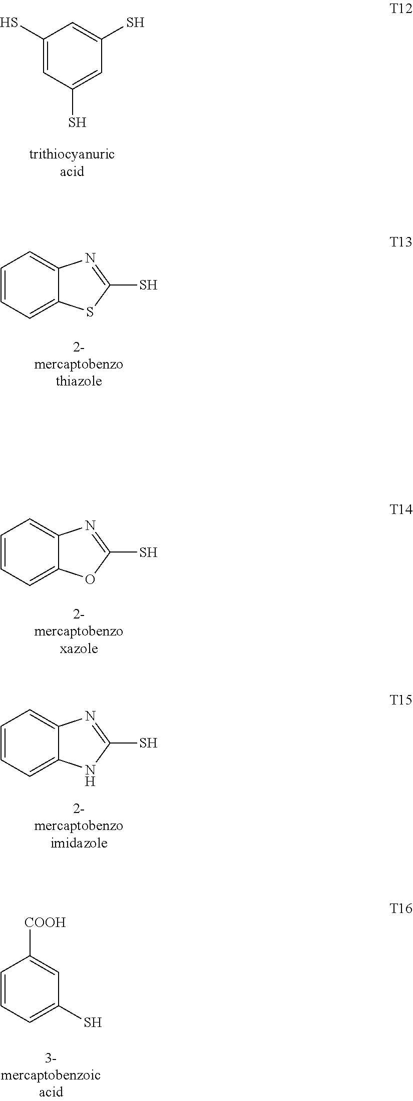 [SMILES: Sc1cc(S)cc(S)c1 ; Sc1nc2ccccc2s1 ; Sc1nc2ccccc2o1 ; Sc1nc2ccccc2[nH]1 ; O=C(O)c1cccc(S)c1]

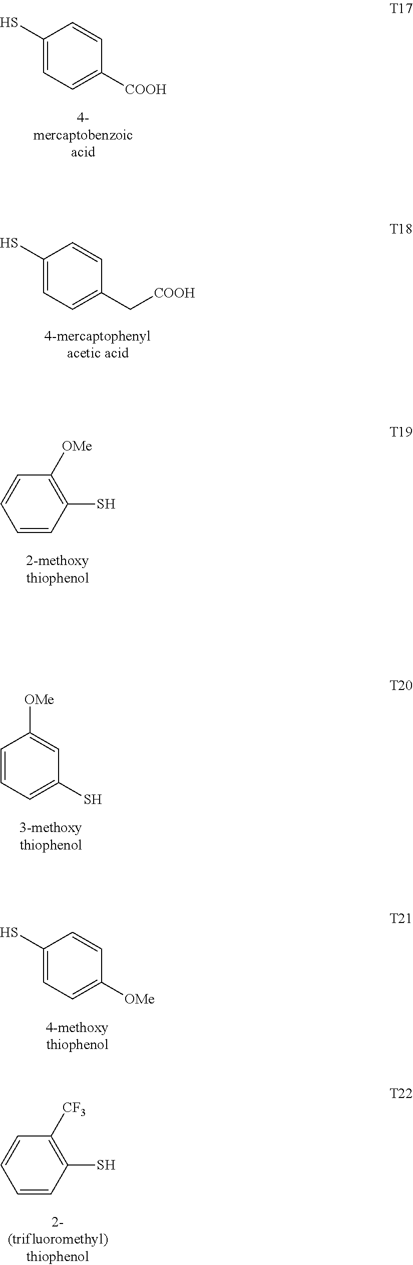 [SMILES: O=C(O)c1ccc(S)cc1 ; O=C(O)Cc1ccc(S)cc1 ; COc1ccccc1S ; COc1cccc(S)c1 ; COc1ccc(S)cc1 ; FC(F)(F)c1ccccc1S]

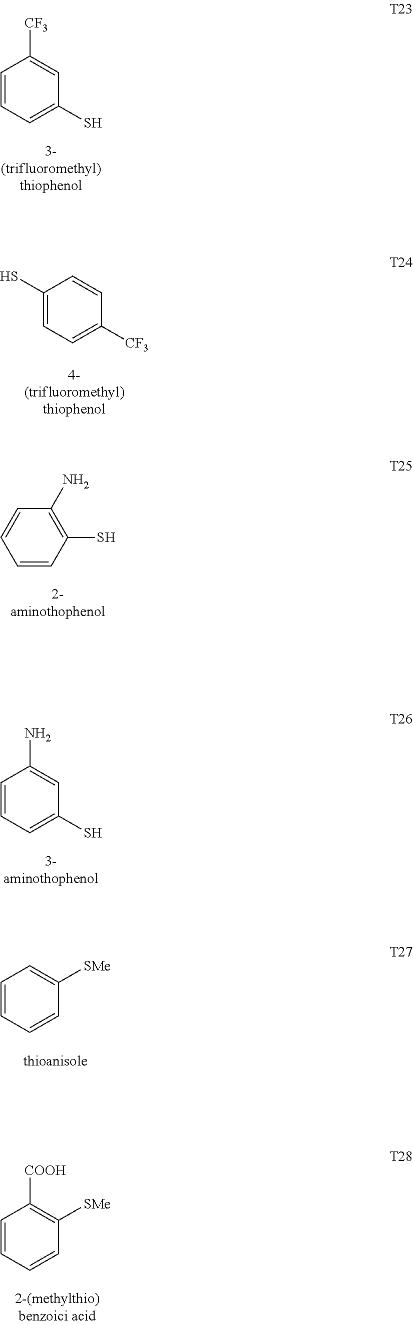 [SMILES: FC(F)(F)c1cccc(S)c1 ; FC(F)(F)c1ccc(S)cc1 ; Nc1ccccc1S ; Nc1cccc(S)c1 ; CSc1ccccc1 ; CSc1ccccc1C(=O)O]

### Kits

In yet another aspect, the disclosure provides a kit comprising the composition described herein and an instructional material comprising instructions for using the composition. In certain aspects, the composition can be any of the compositions described herein.

Those skilled in the art will recognize, or be able to ascertain using no more than routine experimentation, numerous equivalents to the specific procedures, aspects, claims, and examples described herein. Such equivalents were considered to be within the scope of this disclosure and covered by the claims appended hereto. For example, it should be understood, that modifications in reaction conditions, including but not limited to reaction times, reaction size/volume, and experimental reagents, such as solvents, catalysts, pressures, atmospheric conditions, e.g., nitrogen atmosphere, and reducing/oxidizing agents, with art-recognized alternatives and using no more than routine experimentation, are within the scope of the present application.

It is to be understood that wherever values and ranges are provided herein, all values and ranges encompassed by these values and ranges, are meant to be encompassed within the scope of the present disclosure. Moreover, all values that fall within these ranges, as well as the upper or lower limits of a range of values, are also contemplated by the present application.

### EXAMPLES

Various embodiments of the present application can be better understood by reference to the following Examples which are offered by way of illustration. The scope of the present application is not limited to the Examples given herein.

Materials and Methods

Materials. Methyl 3-mercaptopropionate (97%), triphenylmethanethiol (97%), thiobenzoic acid (technical grade, 90%), 1-napthalenethiol (99%), 4,4′-thiobisbenzenethiol (98%), 2-mercaptopyridine (99%), trithiocyanuric acid (95%), 2-mercaptobenzothiazole (97%), 2-mercaptobenzooxazole (95%), 2-mercaptobenzoimidazole (98%), 3-mercaptobenzoic acid (95%), 4-mercaptobenzoic acid (99%), 4-mercaptophenylacetic acid (97%), 2-methoxythiophenol (97%), 3-methoxythiophenol (98%), 4-methoxythiophenol, (97%), 2-(trifluoromethyl)thiophenol (96%), 2-aminothiophenol (99%), 3-aminothiophenol (96%), thioanisole (99%), 2-(methylthio)benzoic acid (97%), n-hexyl acrylate (98%, contains 100 ppm hydroquinone), 1,4-butanediol divinyl ether (98%), pentaerythritol tetrakis(3-mercapotpropionate) (PETMP, >95%), and poly(ethylene glycol) norbornene terminate (PEGNB) Mₙ 10,000 g/mol were purchased from Sigma Aldrich; thioacetic acid (97%), 3-(trifluoromethyl) thiophenol (97%), and 4-(trifluoromethyl) thiophenol (97%) were purchased from Alfa Aesar; 1-hexanethiol (97%) and benzyl mercaptan (99%) were purchased from Fischer Scientific; thiophenol (99%) and 2-mercaptobenzoic acid (98%) were purchased from Acros Organics; poly(ethylene glycol) Mₙ 4,600 g/mol was purchased from JenKem Technology; 2,2-dimethoxy-2-phenylacetophenone (DMPA, >98%) was purchased from TCI Chemicals. Chemicals were used as received, and all thiols were stored under nitrogen and at 10° C. to inhibit thiol reduction to disulfides.

Characterization. ¹H NMR spectra were recorded on a Bruker Avance-III 400 spectrometer.

FTIR kinetic studies. Acrylate homopolymerization and TEC samples were laminated between NaCl plates separated by a 0.051 mm plastic spacer. Thiol (˜2570 cm⁻¹, S—H stretch), alkene (˜3050 cm⁻¹, C—H stretch), and acrylate (1670 cm⁻¹, C═C stretch) conversions were independently monitored in real-time in the mid IR (Nicolet Magna-IR 750 series II FTIR spectrometer) at a collection rate of ˜1 scan per second and a resolution of 1 cm⁻¹. Samples were then irradiated with either a broad wavelength source (Acticure 4000 light source) or monomodal LED light source (Thorlabs DC4104 4-channel LED driver equipped with a Thorlabs collimated LED) and irradiation intensity was measured with a Thorlabs PM100D radiometer. Prior to lamination, all samples were sparged with nitrogen gas to minimize the dissolved oxygen concentration. All FTIR experiments were performed in triplicate.

General experimental procedures hydrogel rheology. Hydrogel formation reactions were prepared by dissolving the appropriately functionalized PEGs in deionized water (10 wt. % PEG in water). Solutions were then aliquoted in 100 μL portions into microcentrifuge tubes and then lyophilized to yield a white powder. Lyophilized samples were then reconstituted in 90 μL of sodium phosphate monobasic (0.5 M) aqueous solution pH 4.4.

Samples were then irradiated with either a broad wavelength source or a 365 nm LED source and the samples rheological properties were monitored in real-time with a TA Instruments Ares-G2 rheometer (1 Hz oscillation frequency, 5% strain, 4 data points per second sampling rate). All rheology experiments were performed in triplicate.

### Example 1: Acrylate Photoinitiation

To evaluate each thiol's relative effectiveness with respect to photo-generating catalytic radicals, the model photopolymerization of n-hexyl acrylate (HA, 3M in DMSO) was conducted with varying amounts of T1-15 (0.3 to 300 mM). Reactions were initiated via a broad wavelength light source (λ=320-390 nm) with intensities of 10.0, 8.5, and 31 mW cm⁻² at 320 nm, 365 nm, and over all wavelengths combined, respectively. Acrylate conversion was monitored using real-time FTIR and final conversions were determined by ¹H NMR analysis of the FTIR samples after irradiation. Table 2 summarizes rates of acrylate photopolymerization for acrylates T1-T15.

TABLE 2
Rates of acrylate photopolymerization with thiols
as photoinitiators initiated with 320-390 nm light^{a}

| | | | Acrylate conversion |
|---|---|---|---|
| | [SH] | Rate of acrylate | after 15 min of |
| Thiol | (mM) | conversion (M min⁻¹)^{b} | irradiation (%)^{c} |
| T1 | 300 | — | 55 ± 6 |
| T2 | 300 | — | 50 ± 4 |
| T3 | 300 | — | 66 ± 4 |
| T4 | 30 | — | 31 ± 2 |
| T5 | 30 | 0.23 | 90 ± 3 |
| T6 | 30 | 2.1 | 100 |
| T7 | 30 | 3.1 | 100 |
| T8 | 30 | 3.2 | 100 |
| T9 | 30 | 3.6 | 100 |
| T10 | 60^{d} | 4.2 | 100 |
| T11 | 30 | 0.98 | 90 ± 2 |
| T12 | 30 | 0.94 | 89 ± 3 |
| T13 | 30 | — | 74 ± 3 |
| T14 | 30 | — | 49 ± 6 |
| T15 | 30 | — | 32 ± 5 |

^{a}Reactions were formulated with HA (3M in DMSO) and thiol initiator at varying concentrations. Reactions were initiated with 320-390 nm light with intensities of 10.0, 8.5, and 31 mW cm⁻² at 320 nm, 365 nm, and over all wavelengths combined, respectively.
^{b}Rates were calculated only for reactions that achieved ~90% acrylate conversion.
^{c}Conversions measured by 1H NMR.
^{d}T10 is difunctional.

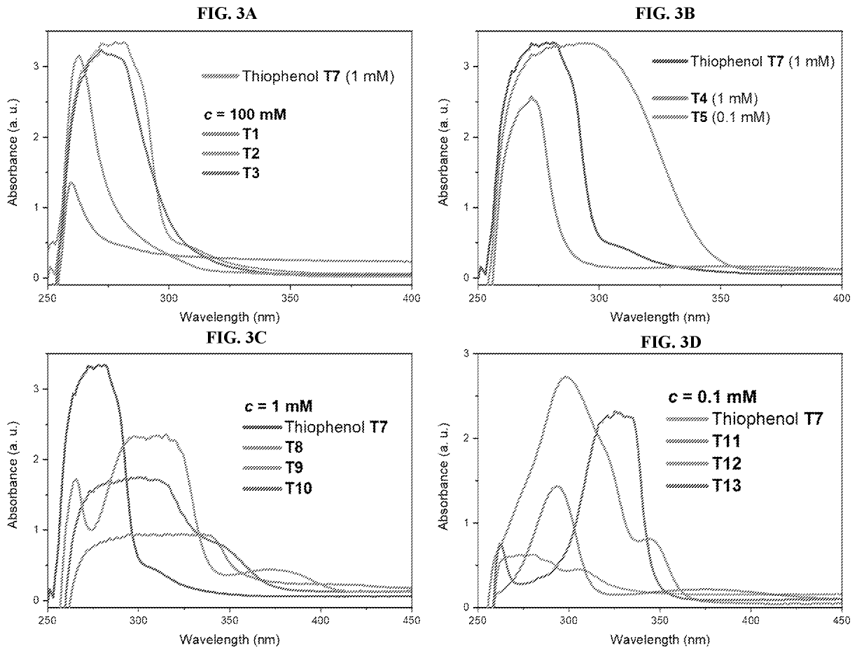

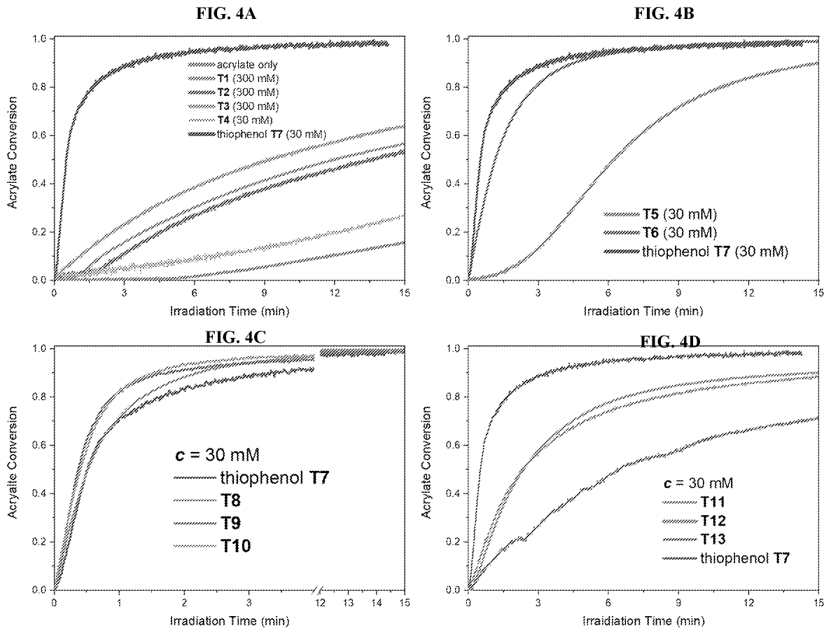

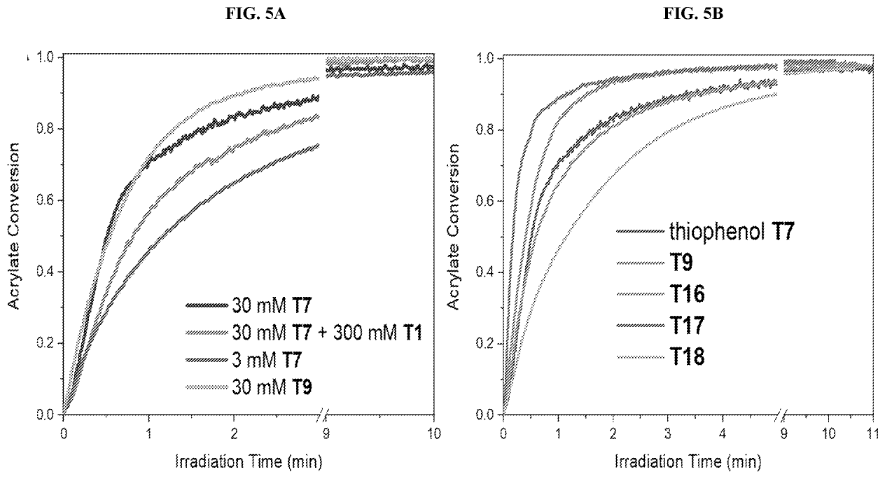

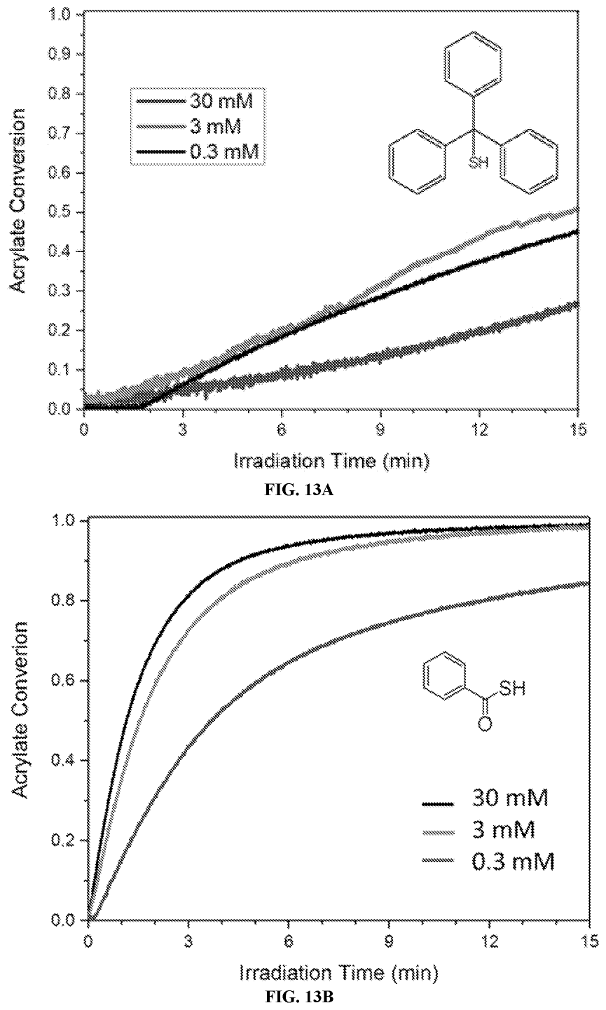

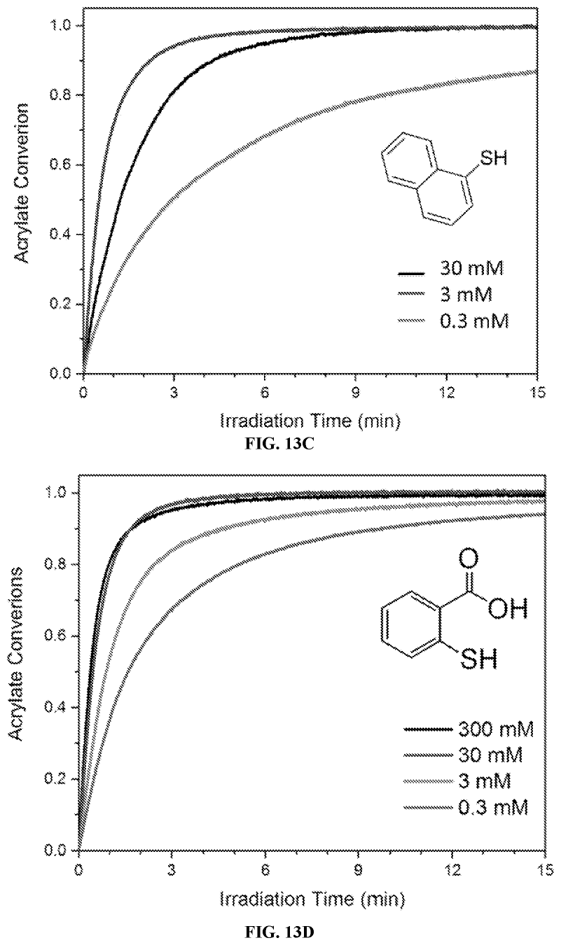

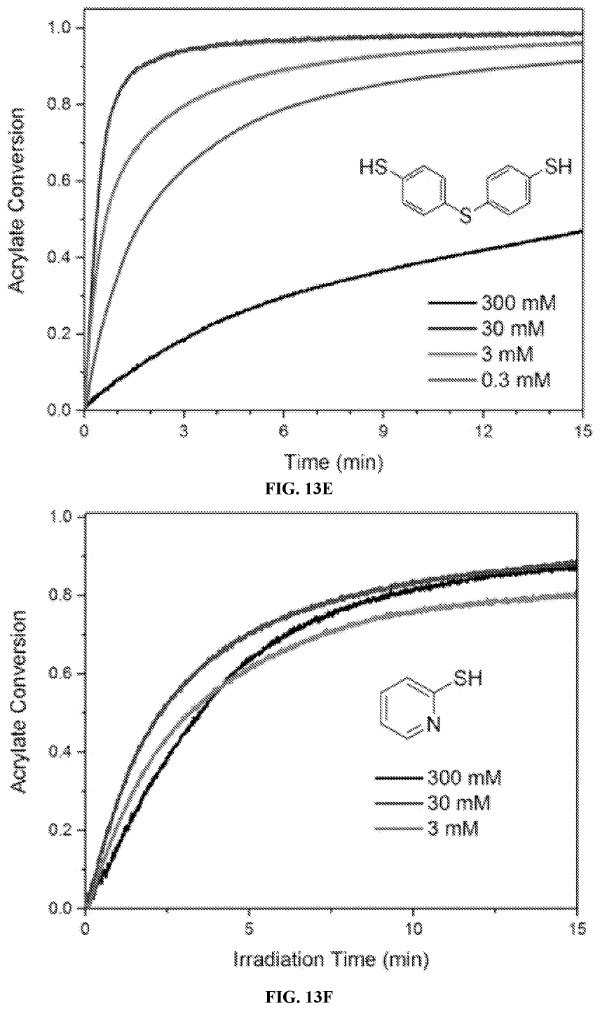

Thiophenol T7 was used as the standard through which to evaluate the photoinitiation effectiveness of all other thiols due to it being the simplest aromatic thiol structure. A comparison of T7's UV/absorption spectra with the alkyl thiols T1-4, thioacids T5 and T6, nonheterocyclic aromatic thiols T7-10, and heterocyclic aromatic thiols T11-13 are shown in FIG. 3, and a comparison of each thiol's ability to photoinitiate the HA polymerization with 10 mol % T1 is shown in FIG. 4. The overall effectiveness follows as non-heterocyclic aromatic>heterocyclic aromatic≈thioacids>alkyl thiols, with the first class of compounds being able to achieve 100% acrylate conversion for each thiol at concentrations ≤3 mM (FIGS. 13A-13F), with the exception of the aromatic thioacid T6, which also achieved 100% at 3 mM (0.1 mol %). The ineffectiveness of the alkyl thiols was expected due to direct σ*SH excitation being the only mode for S—H photolysis and that UV “dark” transition occurring around 260 nm, based on the UV/vis spectrums of T1 and T2 shown in FIG. 3A. The thioacids and aromatic thiols are much more UV active by comparison, which is attributed to the conjugation of the S-atom judging from the drastic differences in UV absorption between T3 and T7. These structurally similar compounds differ only by the presence of a methylene linker between the aromatic ring and the sulfur atom in T3. T6 exhibited the greatest absorptivity of any thiol at wavelengths ≤320 nm, but due to the potential of additional photolysis events possible due to the carbonyl chromophore adjacent to an S-atom, namely C—S fission, their superior effectiveness over alkyl thiols for photoinitiation currently cannot be solely attributed to S—H photolysis.

The non-heterocyclic aromatic thiols constitute the four most effective PIs (photoinitiators), ordering T9>T10>T8>T7, which also is the order of their relative UV absorptivities at λ≥320 nm. Based on prior studies, the superior performance of T9 and T8 relative to T7 is surprising since long-lived, non-dissociative triplet states do not manifest in the latter, while significant deactivation through triplet-state mediated deactivation is observed in both mercaptobenzoic acid and naphthalene thiol derivatives. T9 and T10 both reach max effectiveness at 30 mM with increasing thiol concentration drastically reducing the rate for the T10 reaction, suggesting it undergoes CT and/or affords a more stabilized thiyl radical than T9, since further increasing the concentration of T9 results in nearly identical kinetics (FIGS. 13D-13E). The heterocyclic aromatic thiols, despite generally having greater absorptivity at λ>320 nm than non-heterocyclic aromatic thiols, particularly the T13-15 series of analogues, were much less effective. As the SH photolysis of heterocyclic aromatic thiols has not been studied, these results clearly demonstrate extremely different photodynamic processes are at play that may include more prominent triplet-state mediated relaxation or reduced conjugation of the S-atom to the aromatic system.

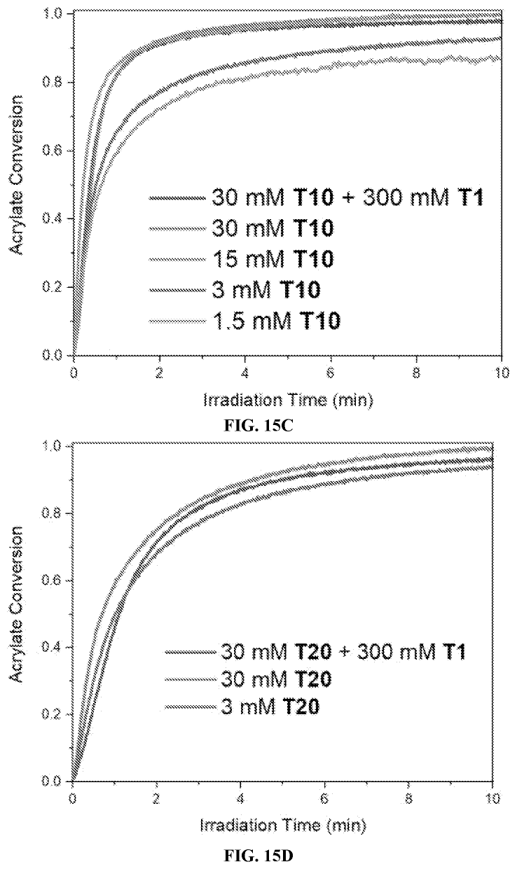

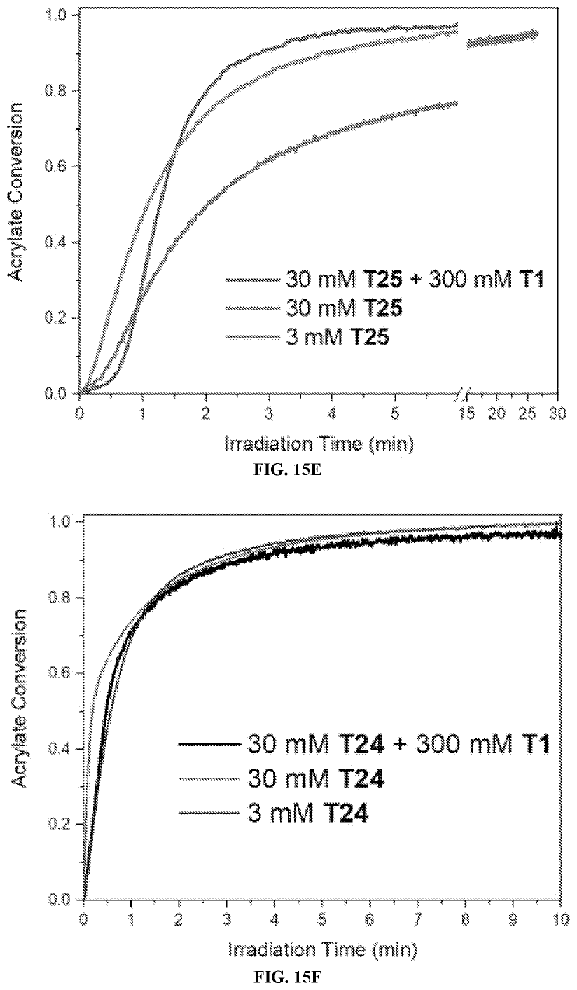

Initiation effectiveness was then compared for reactions with and without the presence of T1 as a CT agent. FIG. 5A compares the reaction initiated by T7 with CT agent and the reaction initiated by T7 and T10 without CT, showing that removal of the CT agent only slightly reduces the polymerization kinetics, but 100% acrylate conversion is still achieved at 3 mM and 30 mM loadings. Further, these results indicate that the reaction rate for T9 initiated systems without CT agent is still faster than T7 with CT agent. Comparisons for T6, T9, T10, T11, T20, T24, and T25 initiated reactions are shown in FIGS. 15A-15F, showing similar trends to that of T7 with T20 and T24 exhibiting nearly identical kinetics over the three conditions: 30 mM with CT agent, 30 mM, and 3 mM thiol loading. These results show that the T1 CT agent does aid kinetics to some degree, but the CT ability of the aromatic thiols are more than adequate to prevent significant oxygen interference.

Due to the success of T9 as an initiator, the meta- and para-substituted mercaptobenzoic acids (T16 and T17, respectively) were also evaluated, along with the analogous T18 in which the carbonyl is no longer conjugated to the aromatic moiety. The rates of the HA reaction photoinitiated by these thiols, and T7 for comparison, are shown in FIG. 5B. Results establish that having the carbonyl conjugated at the para- and ortho-positions produces the greatest rates, while meta-substitution produces kinetics slightly slower than T7. The reduced effectiveness of T18 indicates that conjugation of the carbonyl to the aromatic ring is crucial for the superior photodissociation observed in the mercaptobenzoic acids. Initially, it was thought that the high effectiveness of T9 was due to the proximity of the carbonyl oxygen that could facilitate a combination of SH destabilizing hydrogen bonding between the thiol and carbonyl and/or photogeneration of a triplet state centered over the carbonyl C═O bond that then could intramolecularly abstract the hydrogen from the thiol. The latter would result in a thiyl radical and a radical on the phenyl carbon, like the mechanism of a Norrish Type II initiator system. These results show this mechanism to be unlikely since the para-substituted, which cannot have intramolecular interactions, yielded superior kinetics compared to the ortho version.

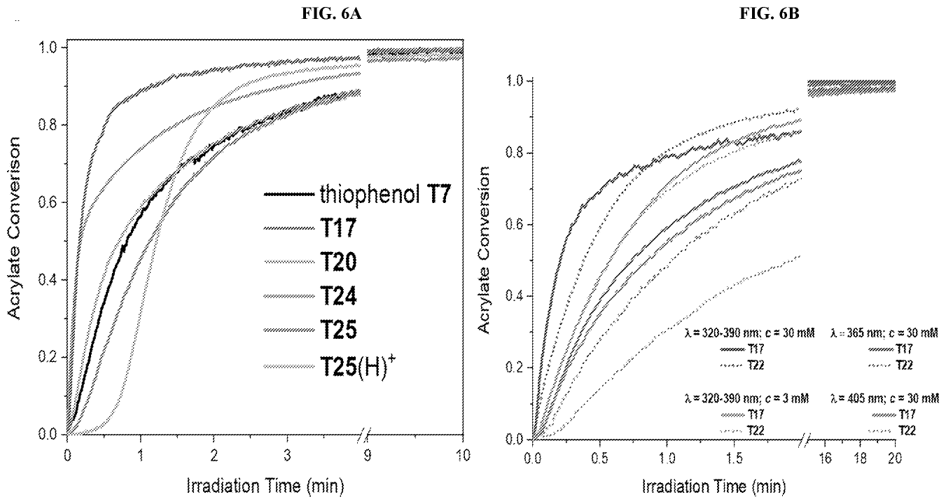

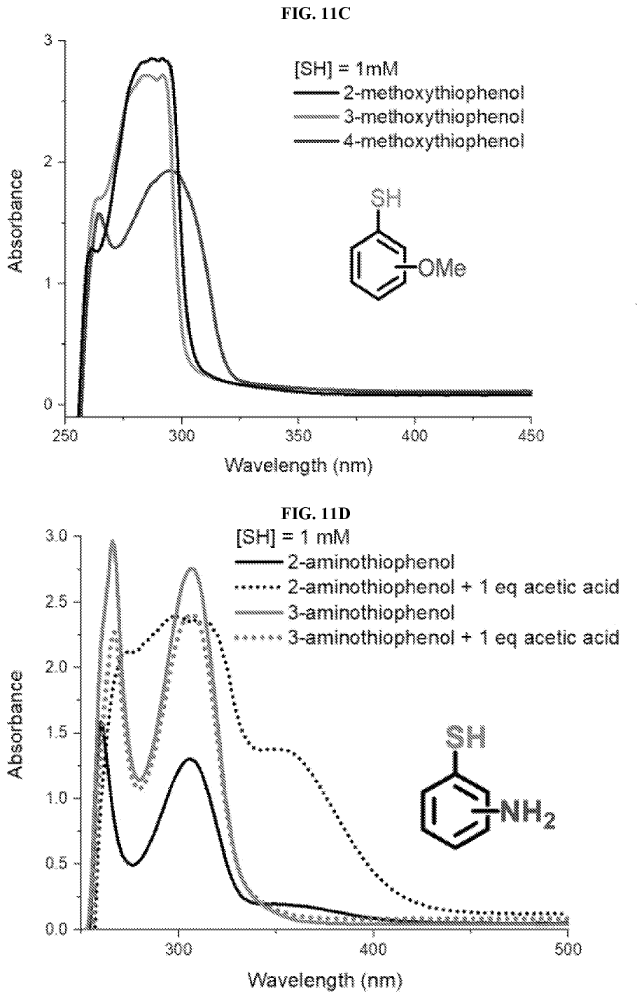

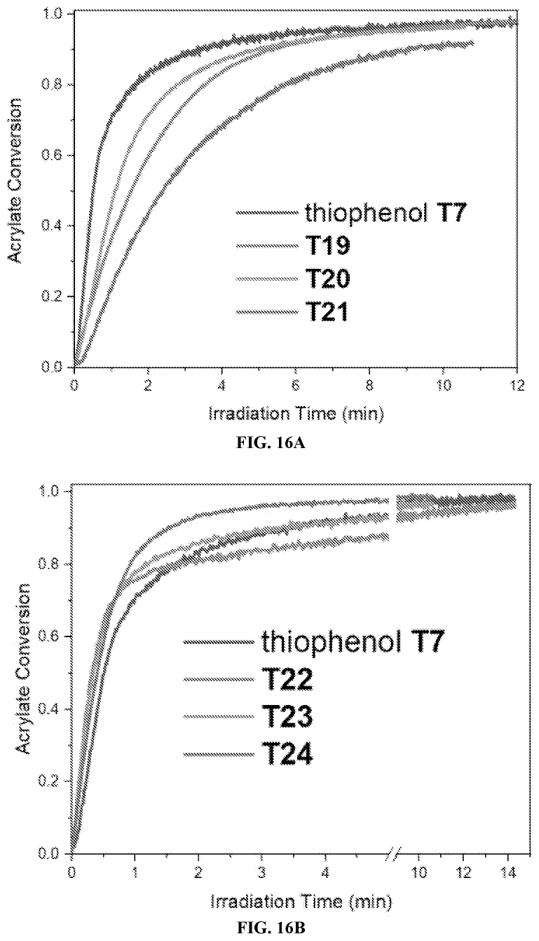

Thiophenols with methoxy (T19-21), trifluoromethyl (T22-24), and primary amine (neutral (T25 and T26) or protonated with 1 equivalent of acetic acid (T25(H)+ and T26(H)+)) substitutions were then evaluated to look for trends between electron withdrawing/donating character and substitution position (see FIG. 6A for the fastest kinetics for each substituent class at 30 mM loading). Kinetics for the reactions initiated by these thiols are shown in FIGS. 16A-16B and comparisons of their UV/vis absorption profiles are shown in FIGS. 11A-11B. Overall, initiation effectiveness for substituents follows as trifluoromethyl≈carboxylic acid>thiophenol>methoxy>protonated amine>neutral amine, which follows the trend of electron withdrawing (EW) substituents increasing the relative effectiveness and electron donating (ED) groups reducing the effectiveness. Additionally, EWD groups increase the effectiveness most when placed at the para position followed closely by the ortho position, whereas the opposite trend is observed for methoxythiophenols. Although the aminothiophenols were promising based off the ortho-substituted T25 isomer, the meta-substituted T26 isomer (neutral and pronated) showed inadequate photoinitiation at loadings of 30 mM to achieve 100% acrylate conversion. Rather interesting is the contrasting behavior of how the UV/vis profiles and photoinitiation effectiveness change for T25 and T26 when they are protonated. T26 and T26(H)+ have nearly identical UV/vis absorption spectrums (FIGS. 11A-11B) and similarly poor photoinitiation capacity. T25(H)+, however, is drastically more absorptive than T25 at wavelengths >250 nm. Further, T25(H)+ exhibits a lag time in the photoinitiation reaction but eventually achieves a polymerization rate greater than the steady-state rate of T25.

Up to now all evaluations of thiol PI effectiveness were based on a loading of 30 mM (1 mol % with respect to acrylate) and irradiation with a 320-390 nm light source. To expand the evaluation, reactions were initiated with non-heterocyclic aromatic thiols at three additional conditions (I) 3 mM (0.1 mol %) thiol loading with 320-390 nm irradiation with identical intensity as to the previous reactions, 31 mW cm⁻² total, (II) 30 mM with a narrowly distributed LED light source centered about 365 nm with an intensity of 10 mW cm⁻², and (III) 30 mM with a narrowly distributed LED light source centered about 405 nm with an intensity of 10 mW cm⁻². Conversion profiles for T17 and T22 at each condition are shown in FIG. 6B, and final conversions and rates for all thiols are given in Table 3.

TABLE 3
Rates of acrylate photopolymerization with thiols as photoinitiators

| | c = 3 mM, | | c = 30 mM, | | c = 30 mM, | |
|---|---|---|---|---|---|---|
| | λ = 320-390 nm (31 | | λ = 365 nm (10 | | λ = 405 nm (10 | |
| | | Acrylate | | Acrylate | | Acrylate |
| | Rate of | conversion | Rate of | conversion | Rate of | conversion |
| | acrylate | after 15 min | acrylate | after 15 min | acrylate | after 15 min |
| | conversion | of irradiation | conversion | of irradiation | conversion | of irradiation |
| Thiol | (M min⁻¹)^{b} | (%)^{c} | (M min⁻¹)^{b} | (%)^{c} | (M min⁻¹)^{b} | (%)^{c} |
| T3 | — | — | 0.14 | 75 ± 5 | — | 12 ± 8 |
| T6 | 0.42 | 92 ± 2 | 0.16 | 88 ± 4 | — | — |
| T7 | 1.2 | 100 | 0.45 | 95 ± 2 | 0.35 | 92 ± 3 |
| T9 | 1.1 | 100 | 0.85 | 100 | 0.89 | 100 |
| T10 | 3.0 | 93 ± 4 | 0.53 | 96 ± 1 | 0.93 | 95 ± 3 |
| T17 | 5.5 | 100 | 2.8 | 100 | 2.3 | 100 |
| T20 | 1.4 | 100 | 0.48 | 100 | 0.22 | 87 ± 6 |
| T22 | 1.4 | 100 | 1.8 | 100 | 1.00 | 100 |
| T23 | 2.6 | 97 ± 1 | 0.74 | 97 ± 1 | 0.21 | 88 ± 3 |
| T24 | 1.4 | 100 | 0.95 | 100 | 0.89 | 94 ± 3 |
| T25 | 0.82 | 96 ± 2 | 0.56 | 100 | 1.8 | 100 |
| T25(H)⁺ | 0.16 | 65 ± 3 | 0.30 | 99 ± 1 | — | 65 ± 7 |

^{a}Reactions were formulated with HA (3 M in DMSO) and thiol initiator at varying concentrations.
^{b}Rates were calculated only for reactions that achieved 100% acrylate conversion.
^{c}Conversions measured by ¹H NMR.

Similar effectiveness trends were observed under all three conditions, generally following: mercaptobenzoic acids>(trifluoromethyl)thiophenols>methoxythiophenols T25≈T7≈T10>

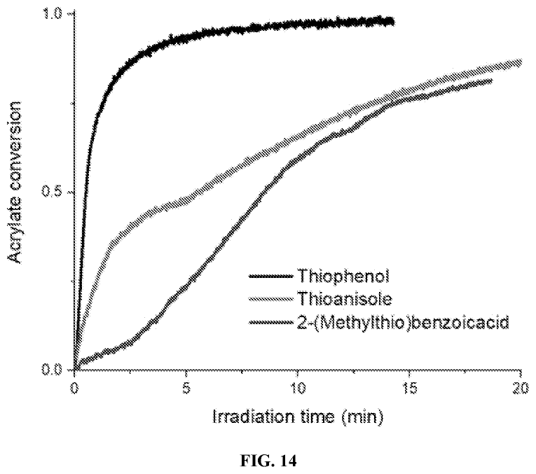

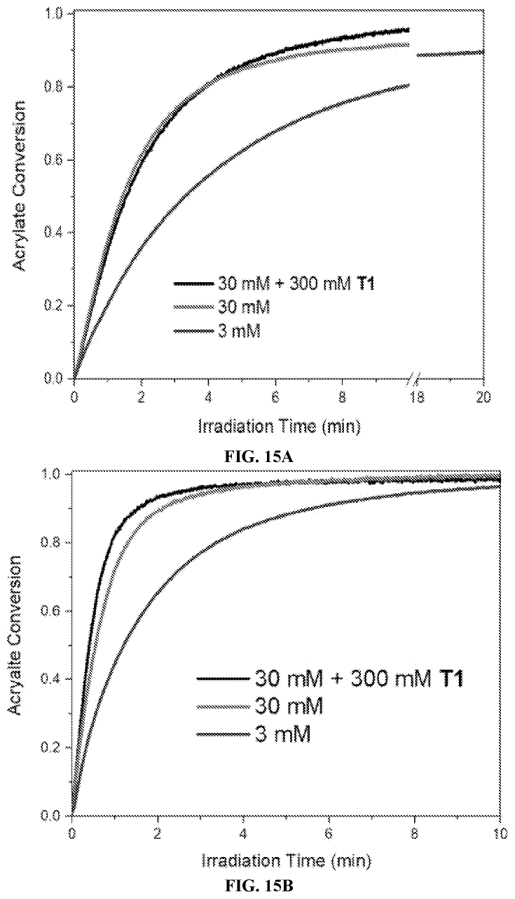

T25(H)+, with T9, T17, and T22 being the only thiols to afford 100% conversion at each condition. A common observation at each condition is that higher reaction rates (calculated between 10 and 30% acrylate conversion) do not always correspond to higher ultimate conversions, e.g., T10 has the 2nd fastest rate under condition I but achieves the 3rd lowest conversion. This distinction highlights that a thiol's effectiveness as an initiator can be limited by the thiol's chain transfer reactivity, as the more reactive thiols may react completely prior to full acrylate conversion. Although, C—S cleavage is possible through the same type of processes that the S—H photolysis undergoes, evidence based on trials with T27 and T28 (FIG. 14) show that this process is inadequate for achieving full conversion. As expected, reaction rates decrease significantly going from a broad wavelength light source to narrowly distributed and longer wavelength light sources due to the lack of absorption bands for most thiols past 350 nm, except for T9, T10, T17, and T24 that have absorption bands that extend to 405 nm at 1 mM in DMSO. It is important to note that they may possess even more redshifted spectra at the concentration employed in these experiments (30 mM), as evidenced by the UV/vis spectrums of T6, T7, and T11, for example.

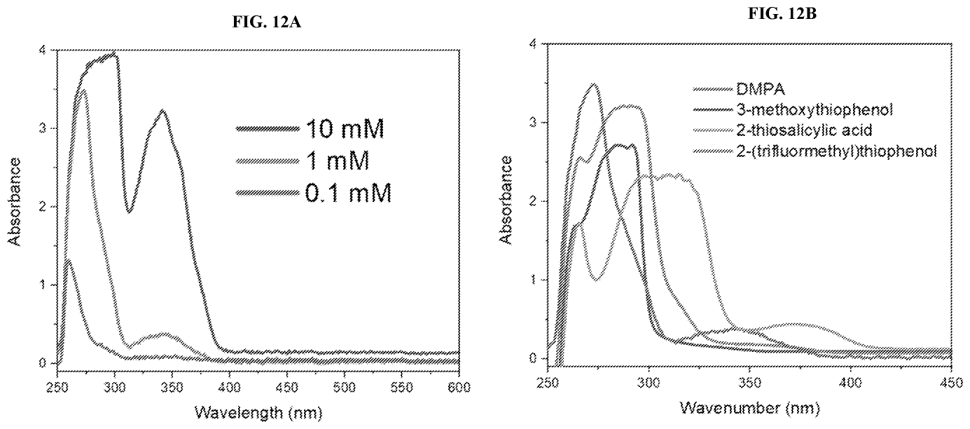

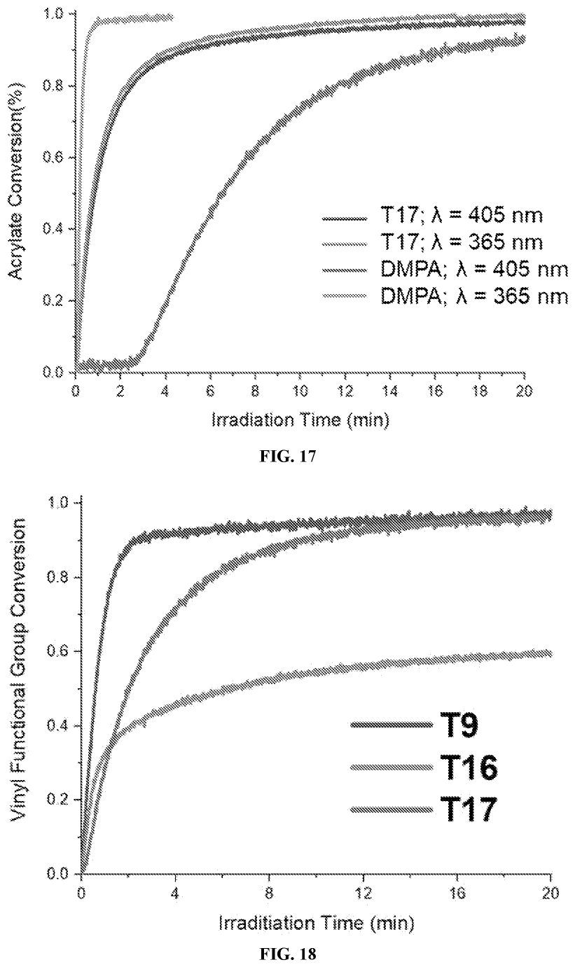

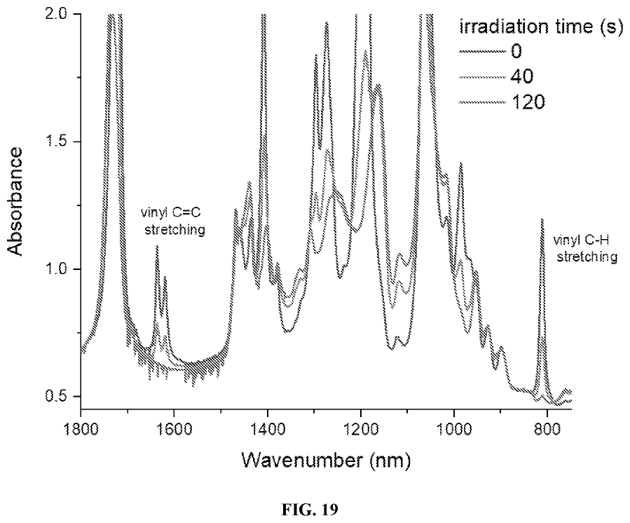

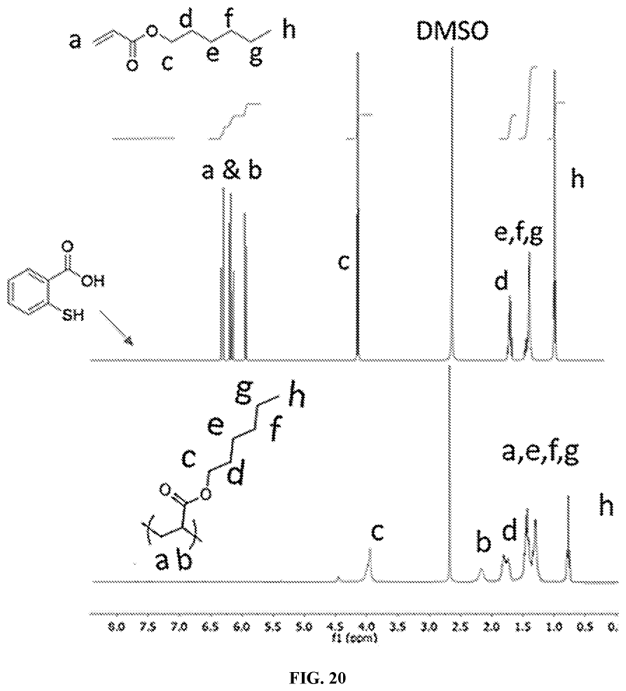

In contrast to commonly used photoinitiators, like 2,2-dimethoxy-2-phenylacetophenone (DMPA), some aromatic thiols exhibit stronger UV absorption spectrums, particularly at λ>400 nm (see FIGS. 12-12B). Additionally, thiols have the potential to perform a dual role as initiator and a chain-transfer agent that enables the polymerization to be oxygen insensitive. The efficacy of DMPA and T17 were compared for initiating HA, where reactions were formulated with 1 wt % of either initiator, and samples were irradiated with 365 or 405 nm light (10 mW cm⁻²). FTIR observation of the kinetics shows that DMPA induces 100% conversion within a few seconds while irradiation with the 405 nm light results in drastically slower kinetics, as well as a ˜2 min induction period and a final conversion of 96% after 30 min irradiation (FIG. 17). T17 is relatively unaffected by the wavelength, reaching >95% conversion within 4 minutes under either condition. Further, the reactions were performed again in scintillation flasks, where reactions were formulated as 1 mm thick films to increase oxygen exposure and diffusivity and conversion was determined by 1H NMR after irradiation. As expected, T17 initiated samples induced full curing with either 365 or 405 nm light, while DMPA only fully cured the sample with 365 nm light. Due to the oxygen enriched reaction environment, DMPA cured samples with 405 nm performed even worse (89±4% after 30 min irradiation) than those studied in the FTIR, which requires the samples to be laminated as a means to reduce oxygen replenishment through diffusion from the air. This example demonstrates that there could be application specific contexts where aromatic thiols outperform traditional photoinitiators by a significant amount.

### Example 2: Photoinitiation of a Thiol-Ene Coupling (TEC) Network Polymerization

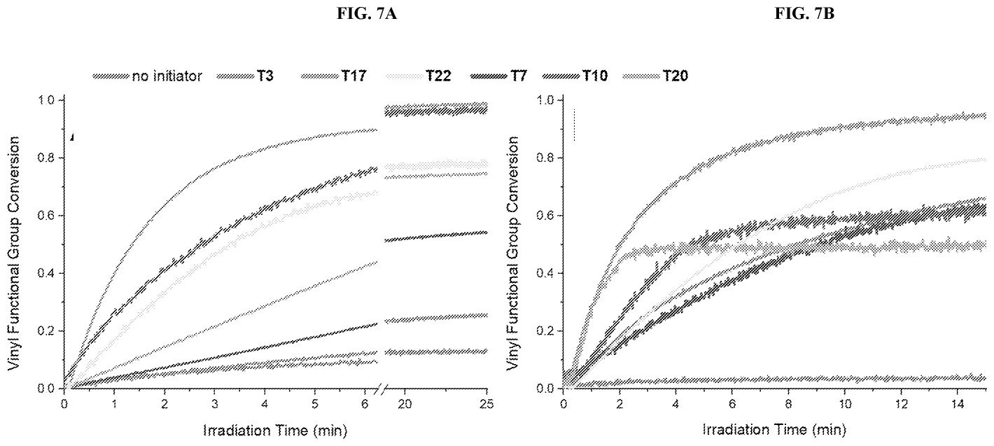

Thiols were used to photoinitiate the bulk TEC network polymerization between the tetrafunctional thiol pentaerythritol tetrakis(3-mercaptopropionate) (PETMP) and the diene, 1,4-butanediol divinyl ether, and [SH]=[ene], where initiator thiols were incorporated at 30 mM and reactions were radiated with narrowly distributed 365 nm or 405 nm light at 10 mW cm⁻² (FIG. 7). T3 was used as a control to compare the effectiveness of the aromatic thiols T7, T10, T17, T20, and T22, with the latter three chosen due to being the most effective of the carboxylic, trifluoromethyl, and methoxy substituted thiophenols studied earlier. The para substituted mercaptobenzoic acid T17 achieved 100% ene conversion at 405 nm. T10 was the only other thiol to achieve 100% conversion at 365 nm. The rest of the mercaptobenzoic acids were tested at 405 nm (FIG. 17) due to the success of T17, while T16 achieved >60% conversion, T9 afforded significantly faster rates and attained full conversion in ˜2 min. Comparatively, with no thiol added, ≤10% ene conversion is achieved. Overall, UV absorption spectra correlate well with the thiol's effectiveness at each wavelength, in contrast to results seen earlier.

### Example 3: Photoinitiation of Solventless TEC Small-Molecule Reactions

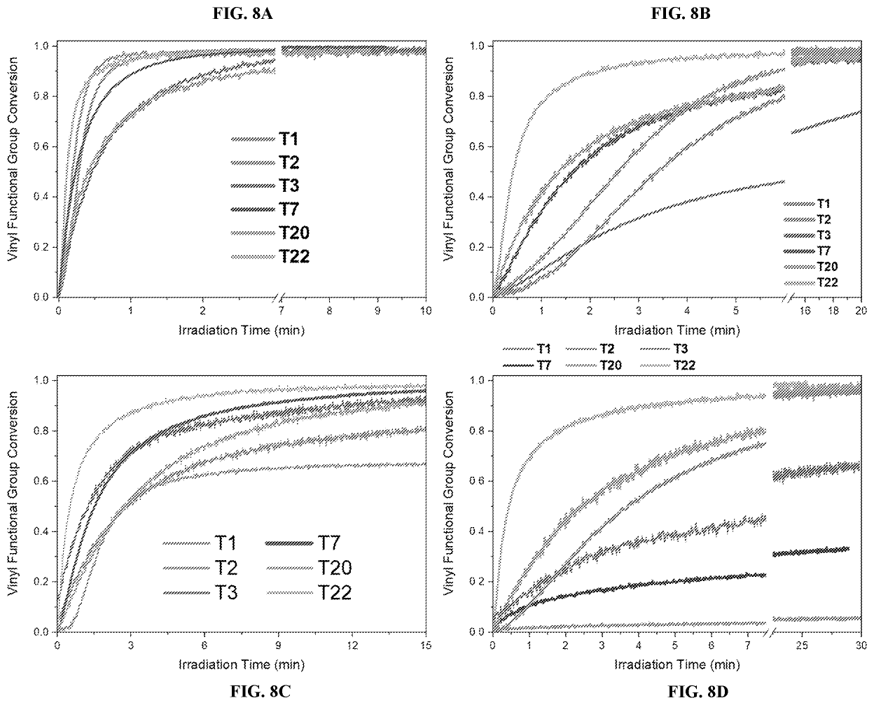

Solventless TEC small-molecule reactions were performed where the liquid thiols T1-3, T7, T20, and T22 were used as initiator and reactant. Two equivalents of thiol were reacted with 1,4-butanediol divinyl ether and the reactions were irradiated with 320-390 nm light with variable intensity, 365 nm light at 10 mW cm⁻², and 405 nm light at 10 mW cm⁻² Each reaction was also performed initially using the photoinitiator 2,2-dimethoxy-2-phenylacetophenone (DMPA, 30 mM) and using 365 nm at 10 mW cm⁻² to compare their relative TEC reactivity (FIG. 18). Unsurprisingly, the alkyl thiols are significantly more reactive to TEC than the aromatic thiols due to phenylthiyl radicals being much more stable and less reactive towards propagation. Additionally, the reaction rates showed negligible variance between structures for both alkyl and aromatic thiols. FIG. 8 shows the ene conversion profiles for the four irradiation conditions used, where all thiols achieve full conversion prior to 5 min irradiation. As irradiation intensity is reduced and the light source becomes more red-shifted, fewer thiols, when used as photoinitiators, are able to achieve full conversion. T22 was the only thiol to achieve 100% conversion with 405 nm irradiation, consistent with the superior performance of (trifluoromethyl)thiophenols relative to other thiols.

### Example 4: Photoinitiation of TEC Hydrogel Polymerization

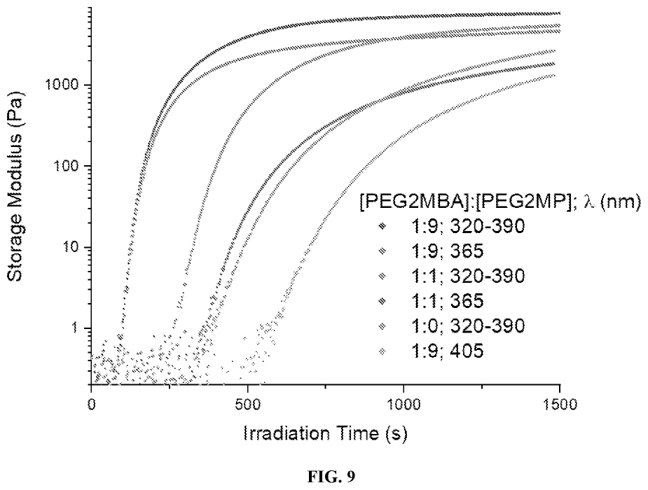

In the final demonstration, initiatorless poly(ethylene glycol) (PEG) hydrogels were prepared via a TEC network polymerization. PEG (Mₙ 4,600 g mol⁻¹) was difunctionalized with either 2-mercaptobenzoic acid (PEG2 MB) or 3-mercaptopropionic acid (PEG2MP) and then reacted with 4-arm PEG tetranorbornene (PEG4NB, Mₙ 10,500 g mol⁻¹) in an aqueous sodium phosphate monobasic solution of pH=4.4 to prevent the formation of retardive thiolate anions. Reactions were formulated with equal concentrations of thiol and norbornene functional groups (10 wt. % PEG monomer in water) and [PEG2 MB]:[PEG2MP] ratios of 1:0, 1:1, and 1:9. Mixtures were then irradiated with either 320-390 nm light (31 mW cm⁻² overall wavelengths combined), 365 nm, or 405 nm, both at 10 mW cm⁻², and their rheological properties were monitored in real-time (FIG. 9) during the reaction. Formulations with 1:9 ratio of aromatic thiol to alkyl thiol PEG monomers achieved gelation after ˜90 s with 320-390 nm and 365 nm light sources, while the 1:0 formulation gelled only with 320-390 nm light after ˜400 s irradiation. 1:1 formulations also gelled with 320-390 nm and 365 nm light but only after much longer irradiation times as compared to the 1:9 reactions.

Additionally, the 1:9 reaction was the only one to gel with 405 nm irradiation, after ˜500 s irradiation. The three fastest reactions also produced the three highest final storage moduli between 5.1 and 7.9 kPa, similar to the final modulus, 8.2±0.6 kPa, obtained from curing the reaction of PEG2MP with PEG4NB using Irgacure 2959 as a PI with 320-390 nm irradiation. The superior performance of the 1:9 versus 1:1 and 1:0 formulations demonstrates that only a small quantity of aromatic thiol is capable of initiating the TEC reaction of a more reactive thiol even under highly dilute conditions, but too high of an aromatic thiol concentration begins to the retard the kinetics as a result of the more stable phenylthiyl radical. Though it is promising that 405 nm light was able to cure one of the formulations, the slow kinetics and reduced storage modulus achieved indicates that either a more efficient thiol initiator or photosensitizer additive is needed for initiating macromolecular TEC reactions using aromatic thiols for wavelengths >365 nm. Overall, this demonstration is particularly promising for preparing hydrogels that do not require toxic initiators and/or their byproducts. Additionally, having a thiol as a dual reactant, initiator, and CT agent could potentially reduce the amount of damaging oxygen radicals being formed in the synthesis of cell encapsulating hydrogels.

Synthesis of poly(ethylene glycol)-bis(3-mercaptopropionate) (PEG2MP) and poly(ethylene glycol)-bis(2-mercaptobenzoic acid) (PEG2MBA). To a flame dried 500 mL round bottom flask, poly(ethylene glycol) Mₙ=4,600 g/mol (5.0 g, 1.09 mmol) was dissolved in 150 mL of toluene at 90° C. Sodium sulfate anhydrous (5.0 g) and 20 mmol of 3-mercaptopropionic acid or 60 mmol of 2-mercaptobenzoic acid were added to the reaction mixture. The reaction was stirred overnight at 90° C. and then was precipitated into 500 mL of ice-cold diethyl ether. The precipitate was isolated by filtration and then dissolved into 300 mL of deionized water. The aqueous phase was washed with ethyl acetate (2×100 mL) and then product was extracted into DCM (3×100 mL). The DCM phase was then washed with water and then dried with sodium sulfate. The DCM was then removed under vacuum to afford the thiol functionalized product as a free flowing white powder. PEG2MP. Yield (4.2 g, 81%). ¹H NMR (400 MHz, CDCl₃) 3.65 (m, O—CH₂—CH₂—O), 2.82-2.75 (m, 4H), 2.70 (td, 4H). PEG2MBA. Yield (4.5 g, 84%). ¹H NMR (400 MHz, CDCl₃) 3.66 (m, 0-CH₂—CH₂-0), 7.49-7.13 (m, 4H).

### Example 5: Improving Polymer Yield by Reducing Cyclization Using

Aromatic thiols such as thiophenol and its substituted derivatives have S—H BDEs (bond dissociation energies) of ≥8 kcal lower than alkyl thiols, indicating that their kinetic barrier towards H-abstraction should be ˜3 orders of magnitude lower (assuming BDE activation energy). In various embodiment as described herein, aromatic thiols can be used as photoinitiators at λ>320 nm and operate through the photolysis of the S—H bond. Therefore, these two aspects can be combined by initiating with an external thiol that sequesters the thiyl radical population upon initiation and prevents monomer cyclization.

To test this strategy, the relative selectivity of thiophenol towards CT (chain transfer) versus alkyl thiols was evaluated through small-molecule reactions formulated with two thiols in equal stoichiometry (3 M) and the alkene VAc (N-methyl-N-vinylacetamide) or AAc (allyl acetate) (both 1.5 M). Reactions were performed in THE using DMPA (0.015 M) and 365 nm light (10 mW cm²) to initiate. After 10 min of irradiation, ¹H NMR analysis of the crude reaction mixtures was performed to determine alkene conversion and the ratio of the thiophenol to alkyl thioether adducts. For the AAc reactions, NMR revealed that thiophenol adducts were selectively formed at ratios of 9.2:1, 8.4:1, and 6.5:1 with 1-hexanethiol, methyl 3-mercaptopropionate, and methyl 2-mercaptoacetate, respectively, as competitive thiol reactants. Since thiol selectivity is based only on the thiol's rate towards CT, the overall selectivity for the reaction follows the following relation: S_{A,B}=∫[(k_{CT}*[SH])ₐ/(k_{CT}*[SH])_{b}]dt; where S_{A,B} is the selectivity of thiol A to react over thiol B.

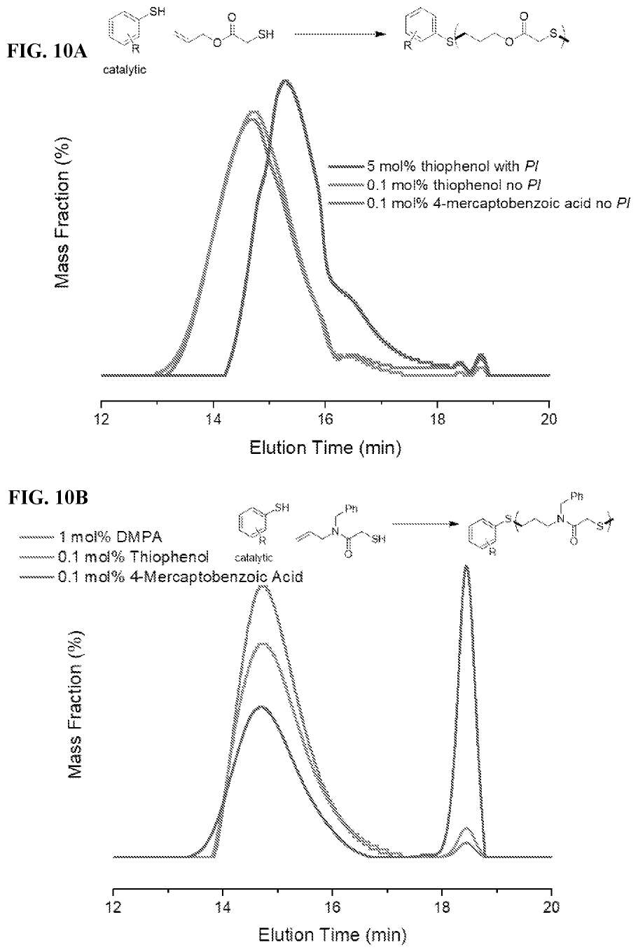

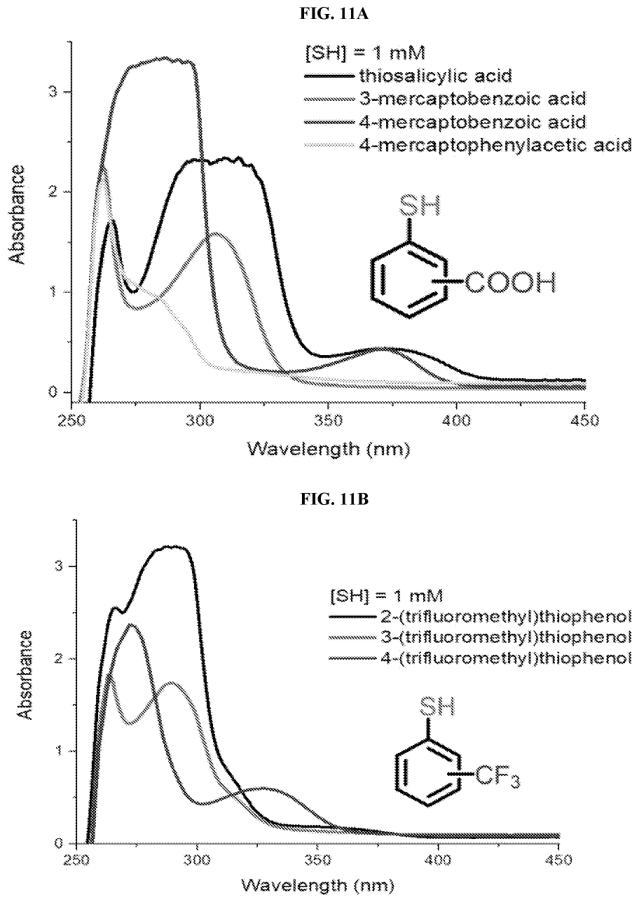

Next, the aromatic thiols thiophenol and 4-mercatpbenzoic acid, previously demonstrated to be highly effective at initiating TEC and acrylate hompolymerizations at concentrations ≤30 mM, were formulated into the polymerizations of 6 and 1 as a CT agent at 5 mol % or as photoinitiators at 0.1 mol % (3 mM) (FIGS. 10A-10B). In both reactions, the degree of cyclization is dramatically reduced, e.g., from 58% cyclization in 6 to 6% using 4-mercaptobenzoic acid as the initiator.

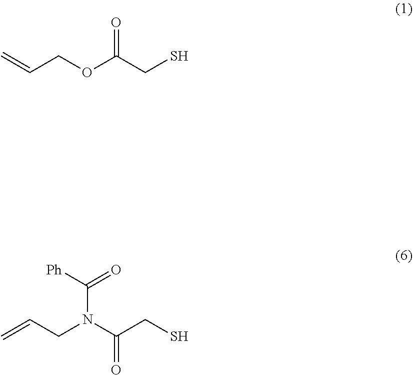

Using thiophenol as a CT agent also reduced cyclization to a similar degree, but, as expected, this also greatly reduces the final molecular weight due to an excess of a mono-functional reactant that end caps the polymer and results in a large shoulder at the lower MW end of the polymeric peak. The latter is attributed to the increased in low MW polymer products terminated by the mono-functional thiol. The success of 4-mercaptbenzoic acid as a PI for hetero-TEC reactions is unexpected as the carboxylic group allows for attachment of this moiety onto macromolecules for the preparation of a macroinitiator to synthesize grafting-from copolymers.

The terms and expressions employed herein are used as terms of description and not of limitation, and there is no intention in the use of such terms and expressions of excluding any equivalents of the features shown and described or portions thereof, but it is recognized that various modifications are possible within the scope of the embodiments of the present application. Thus, it should be understood that although the present application describes specific embodiments and optional features, modification and variation of the compositions, methods, and concepts herein disclosed may be resorted to by those of ordinary skill in the art, and that such modifications and variations are considered to be within the scope of embodiments of the present application.

### ENUMERATED EMBODIMENTS

The following exemplary embodiments are provided, the numbering of which is not to be construed as designating levels of importance:

Embodiment 1 provides a method of polymerizing a substrate, the method comprising irradiating a composition comprising at least one substrate and a photoinitator,

wherein the at least one substrate comprises at least one polymerizable carbon-carbon double bond, and

wherein the photoinitiator comprises a compound of formula (I):

(Ar)ₙ—X—SH (I),

wherein:

Ar is optionally substituted C₆₋₁₈ aryl or optionally substituted C₆₋₁₈ heteroaryl, wherein the optional substitution is by 1 to 5 substituents independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;

X is a bond (absent) or C(═O) and n=1, or X is CH₃₋ₙ and n=1, 2, or 3; and

R at each occurrence is independently hydrogen, C₁-C₁₀ alkyl, or C₆₋₁₀ aryl; thereby forming an at least partially polymerized substrate.

Embodiment 2 provides the method of embodiment 1, wherein n is 1.

Embodiment 3 provides the method of any one of embodiments 1-2, wherein X is a bond.

Embodiment 4 provides the method of any one of embodiments 1-3, wherein Ar is an optionally substituted C₆₋₁₀ aryl or C₆₋₁₀ heteroaryl, wherein the substituent is at least one selected from the group consisting of CF₃, COOH, NH₂, OMe, and CH₂COOH.

Embodiment 5 provides the method of any one of embodiments 1-4, wherein the photoinitiator is selected from the group consisting of

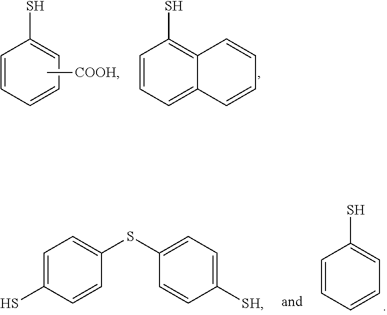

Embodiment 6 provides the method of any one of embodiments 1-5, wherein the photoinitiator is selected from the group consisting of:

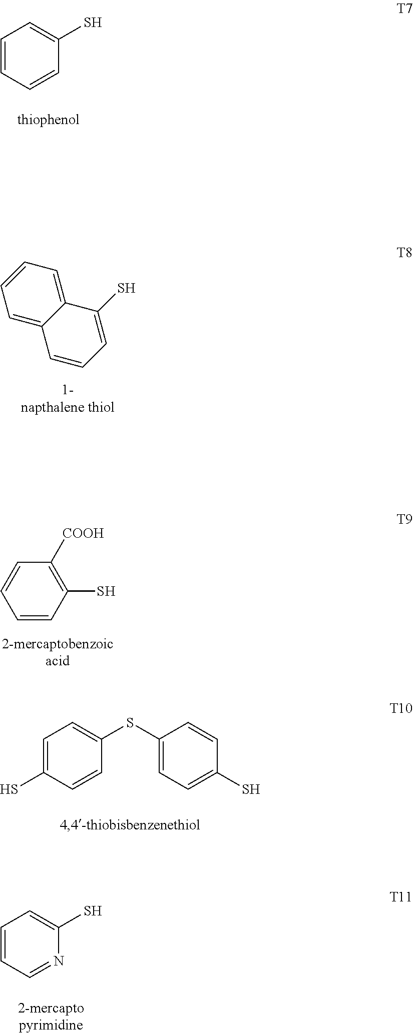 [SMILES: Sc1ccccc1 ; Sc1cccc2ccccc12 ; O=C(O)c1ccccc1S ; Sc1ccc(Sc2ccc(S)cc2)cc1 ; Sc1ccccn1]

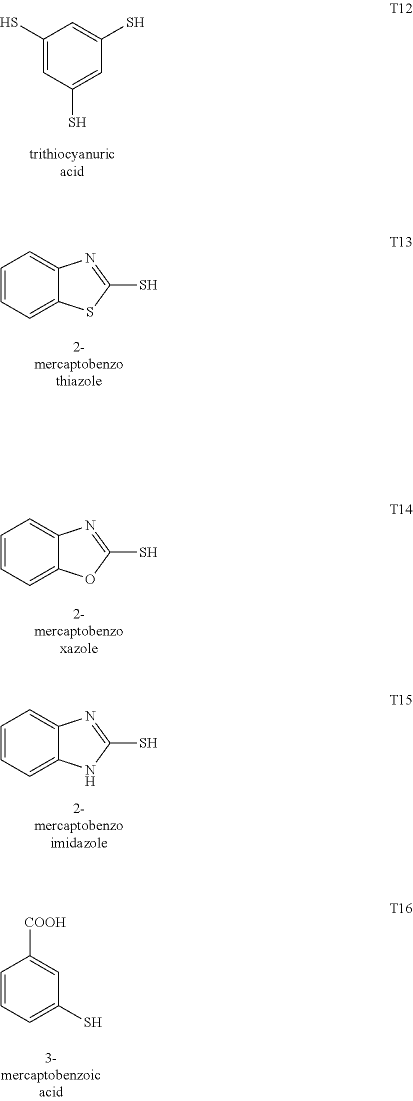 [SMILES: Sc1cc(S)cc(S)c1 ; Sc1nc2ccccc2s1 ; Sc1nc2ccccc2o1 ; Sc1nc2ccccc2[nH]1 ; O=C(O)c1cccc(S)c1]

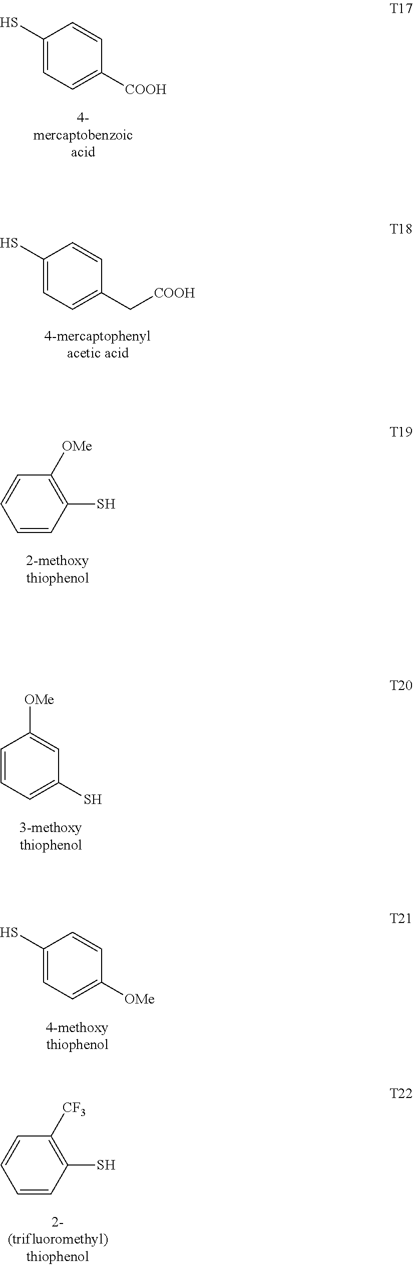 [SMILES: O=C(O)c1ccc(S)cc1 ; O=C(O)Cc1ccc(S)cc1 ; COc1ccccc1S ; COc1cccc(S)c1 ; COc1ccc(S)cc1 ; FC(F)(F)c1ccccc1S]

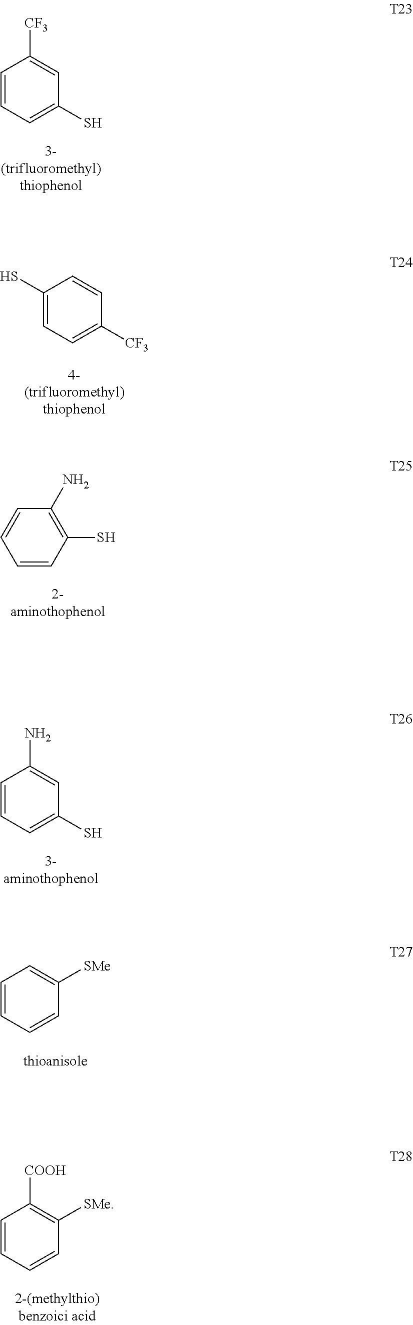 [SMILES: FC(F)(F)c1cccc(S)c1 ; FC(F)(F)c1ccc(S)cc1 ; Nc1ccccc1S ; Nc1cccc(S)c1 ; CSc1ccccc1 ; CSc1ccccc1C(=O)O]

Embodiment 7 provides the method of any one of embodiments 1-6, wherein the substrate has the structure:

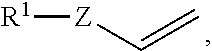

wherein:
Z is —O—, —CH₂—, —C(═O)—, —CH₂O—, —OCH₂—, —CH₂CH₂—, —CH₂C(═O)—, —C(═O)CH₂—, —OC(═O)—, —C(═O)O—, —N(R)CH₂—, —CH₂N(R)—, —C(═O)N(R)—; or —N(R)C(═O)—;
wherein R¹ is selected from the group consisting of C₁₋₂₀ alkyl, C₂₋₂₀ alkenyl, C₂₋₂₀ alkynyl C₁₋₂₀ heteroalkyl, C₃₋₂₀ cycloalkyl, C₃₋₂₀ heterocycloalkyl, C₁₋₂₀ alkyl-C₆₋₁₄ aryl, C₁₋₂₀ alkyl-C₆₋₁₄ heteroaryl, C₁₋₂₀ heteroalkyl-C₆₋₁₄ aryl, C₁₋₂₀ heteroalkyl-C₆₋₁₄ heteroaryl each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;
wherein each occurrence of R is independently hydrogen, C₁-C₁₀ alkyl, or C₆₋₁₀ aryl.

Embodiment 8 provides the method of any one of embodiments 1-7, wherein the substrate comprises at least one thiol-containing monomer and at least one terminal alkene-containing monomer.

Embodiment 9 provides the method of any one of embodiments 1-8, wherein the thiol-containing monomer comprises 2 to 6 thiol groups.

Embodiment 10 provides the method of any one of embodiments 1-9, wherein the alkene-containing monomer comprises 2 terminal alkenes.

Embodiment 11 provides the method of any one of embodiments 1-10, wherein the thiol-containing monomer is selected from the group consisting of:

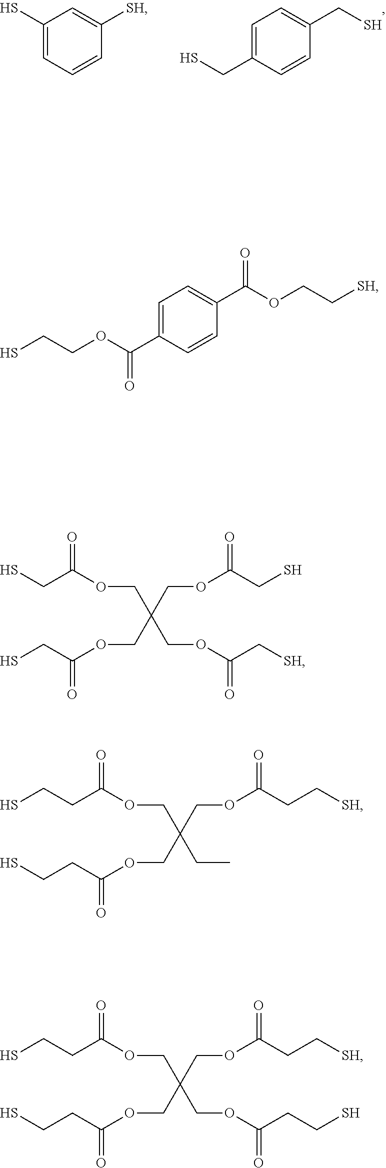 [SMILES: Sc1cccc(S)c1 ; SCc1ccc(CS)cc1 ; O=C(OCCS)c1ccc(C(=O)OCCS)cc1 ; O=C(CS)OCC(COC(=O)CS)(COC(=O)CS)COC(=O)CS ; CCC(COC(=O)CCS)(COC(=O)CCS)COC(=O)CCS ; O=C(CCS)OCC(COC(=O)CCS)(COC(=O)CCS)COC(=O)CCS]

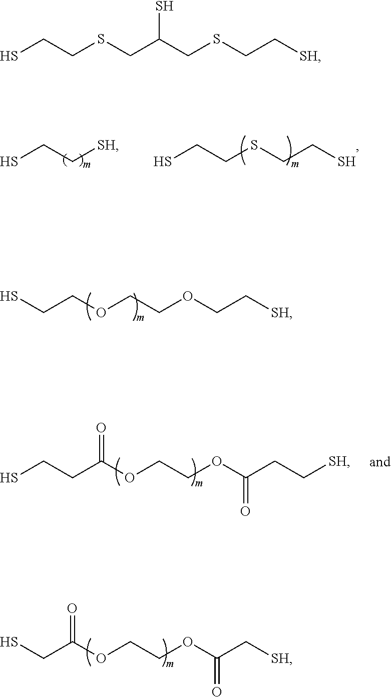

wherein each instance of m is independently an integer from 1 to 25.

Embodiment 12 provides the method of any one of embodiments 1-11, wherein the alkene-containing monomer is selected from the group consisting of:

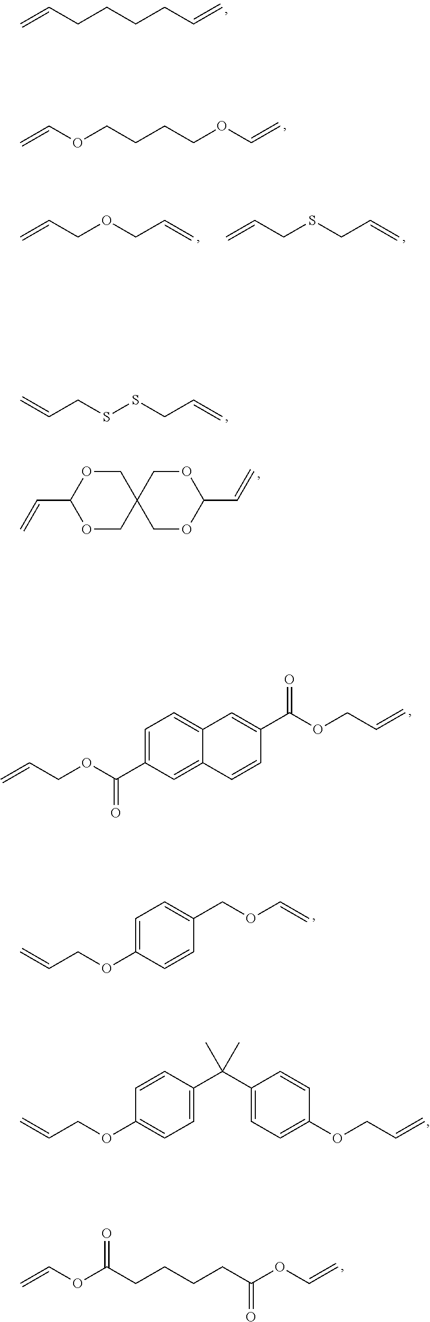

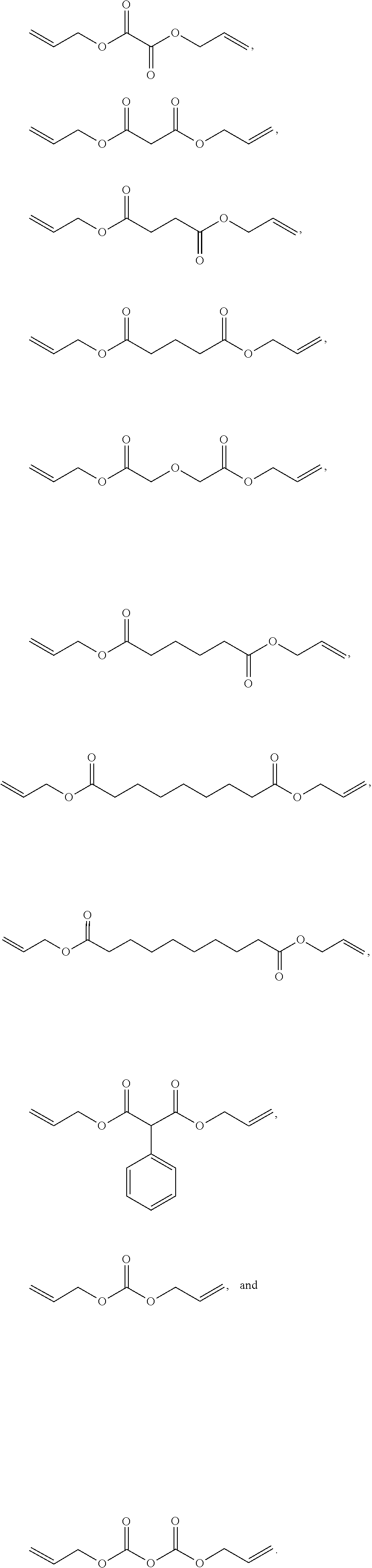

Embodiment 13 provides the method of any one of embodiments 1-12, wherein the composition is irradiated with UV radiation having wavelength of about 380 nm to about 410 nm.

Embodiment 14 provides the method of any one of embodiments 1-13, wherein the irradiation comprises light having intensity of about 1 mW/cm² to about 20 mW/cm².

Embodiment 15 provides the method of any one of embodiments 1-14, wherein Z is —C(═O)—, —CH₂C(═O)—, —OC(═O)—, or —N(R)C(═O)—.

Embodiment 16 provides the method of any one of embodiments 1-15, wherein Y is —O—, —OCH₂—, or —OC(═O).

Embodiment 17 provides the method of any one of embodiments 1-16, wherein R¹ is C₁₋₂₀ alkyl.

Embodiment 18 provides a composition comprising:

at least one substrate comprising at least one polymerizable carbon-carbon double bond; and

a photoinitator comprising a compound of formula (I):

(Ar)ₙ—X—SH (I),

wherein:

Ar is optionally substituted C₆₋₁₈ aryl or optionally substituted C₆₋₁₈ heteroaryl, wherein the optional substitution is by 1 to 5 substituents independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;

X is a bond (absent) or C(═O) and n=1, or X is CH₃₋ₙ and n=1, 2, or 3; and

R at each occurrence is independently hydrogen, C₁-C₁₀ alkyl, or C₆₋₁₀ aryl.

Embodiment 19 provides the composition of embodiment 18, wherein the substrate has the structure:

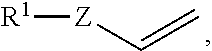

wherein:
Z is —O—, —CH₂—, —C(═O)—, —CH₂O—, —OCH₂—, —CH₂CH₂—, —CH₂C(═O)—, —C(═O)CH₂—, —OC(═O)—, —C(═O)O—, —N(R)CH₂—, —CH₂N(R)—, —C(═O)N(R)—; or —N(R)C(═O)—;
wherein R¹ is selected from the group consisting of C₁₋₂₀ alkyl, C₂₋₂₀ alkenyl, C₂₋₂₀ alkynyl C₁₋₂₀ heteroalkyl, C₃₋₂₀ cycloalkyl, C₃₋₂₀ heterocycloalkyl, C₁₋₂₀ alkyl-C₆₋₁₄ aryl, C₁₋₂₀ alkyl-C₆₋₁₄ heteroaryl, C₁₋₂₀ heteroalkyl-C₆₋₁₄ aryl, C₁₋₂₀ heteroalkyl-C₆₋₁₄ heteroaryl each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;
wherein each occurrence of R is independently hydrogen, C₁-C₁₀ alkyl, or C₆₋₁₀ aryl.

Embodiment 20 provides the composition of embodiment 18, which is a polymerized composition.

Embodiment 21 provides a kit comprising the composition of any one of embodiments 18-20 and an instructional material comprising instructions for using the composition.

1. A method of polymerizing a substrate, the method comprising irradiating a composition comprising at least one substrate and a photoinitator,
wherein the at least one substrate comprises at least one polymerizable carbon-carbon double bond, and
wherein the photoinitiator comprises a compound of formula (I):
(Ar)ₙ—X—SH (I),
wherein:
Ar is optionally substituted C₆₋₁₈ is aryl or optionally substituted C₆₋₁₈ heteroaryl, wherein the optional substitution is by 1 to 5 substituents independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;
X is a bond (absent) or C(═O) and n=1, or X is CH₃₋ₙ and n=1, 2, or 3; and
R at each occurrence is independently hydrogen, C₁-C₁₀ alkyl, or C₆₋₁₀ aryl;
thereby forming an at least partially polymerized substrate.

2. The method of claim 1, wherein n is 1.

3. The method of claim 1, wherein X is a bond.

4. The method of claim 1, wherein Ar is an optionally substituted C₆₋₁₀ aryl or C₆₋₁₀ heteroaryl, wherein the substituent is at least one selected from the group consisting of CF₃, COOH, NH₂, OMe, and CH₂COOH.

5. The method of claim 1, wherein the photoinitiator is selected from the group consisting of

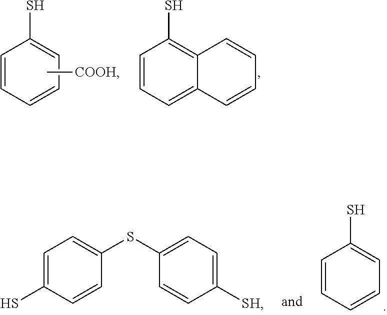

6. The method of claim 1, wherein the photoinitiator is selected from the group consisting of:

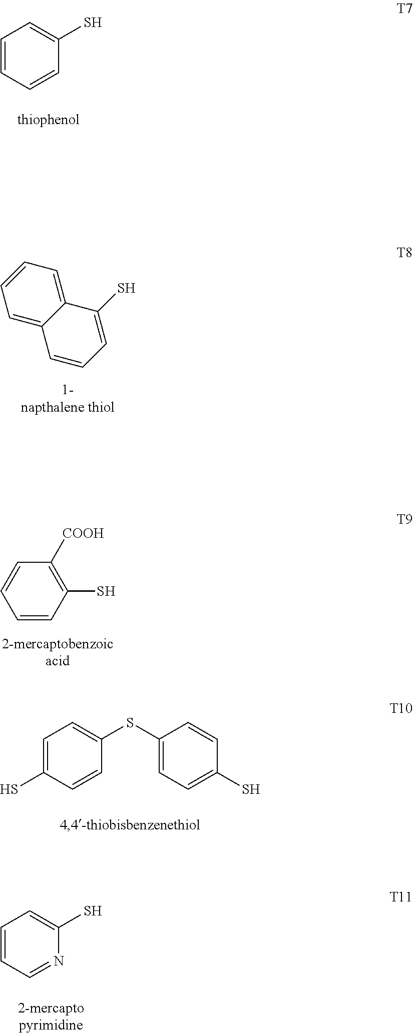 [SMILES: Sc1ccccc1 ; Sc1cccc2ccccc12 ; O=C(O)c1ccccc1S ; Sc1ccc(Sc2ccc(S)cc2)cc1 ; Sc1ccccn1]

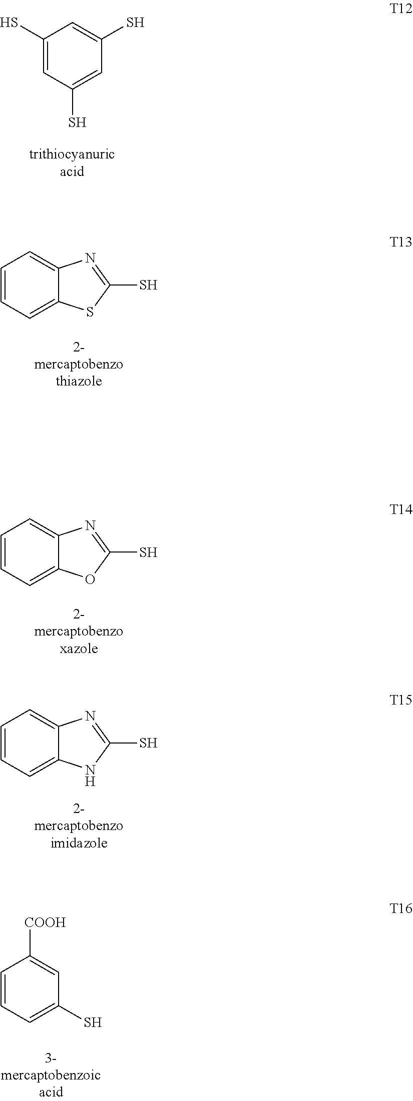 [SMILES: Sc1cc(S)cc(S)c1 ; Sc1nc2ccccc2s1 ; Sc1nc2ccccc2o1 ; Sc1nc2ccccc2[nH]1 ; O=C(O)c1cccc(S)c1]

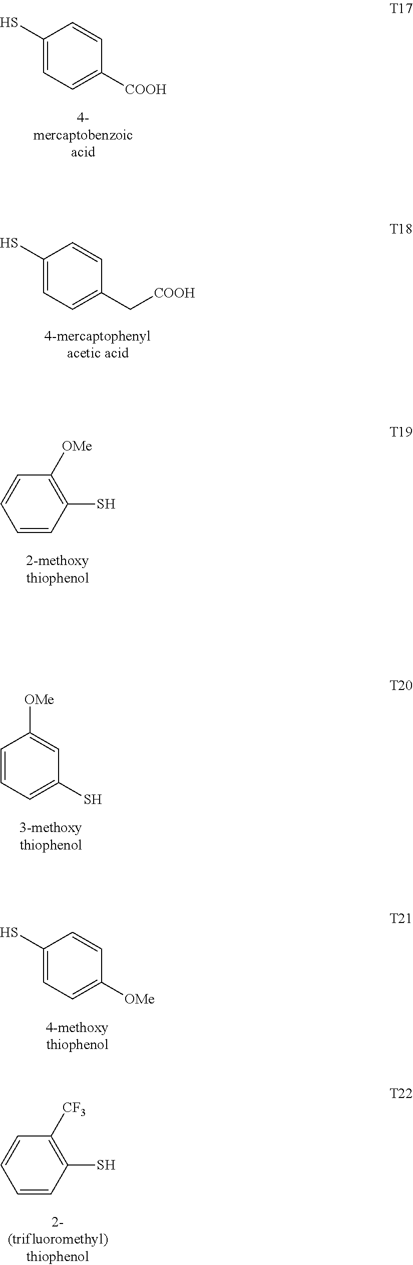 [SMILES: O=C(O)c1ccc(S)cc1 ; O=C(O)Cc1ccc(S)cc1 ; COc1ccccc1S ; COc1cccc(S)c1 ; COc1ccc(S)cc1 ; FC(F)(F)c1ccccc1S]

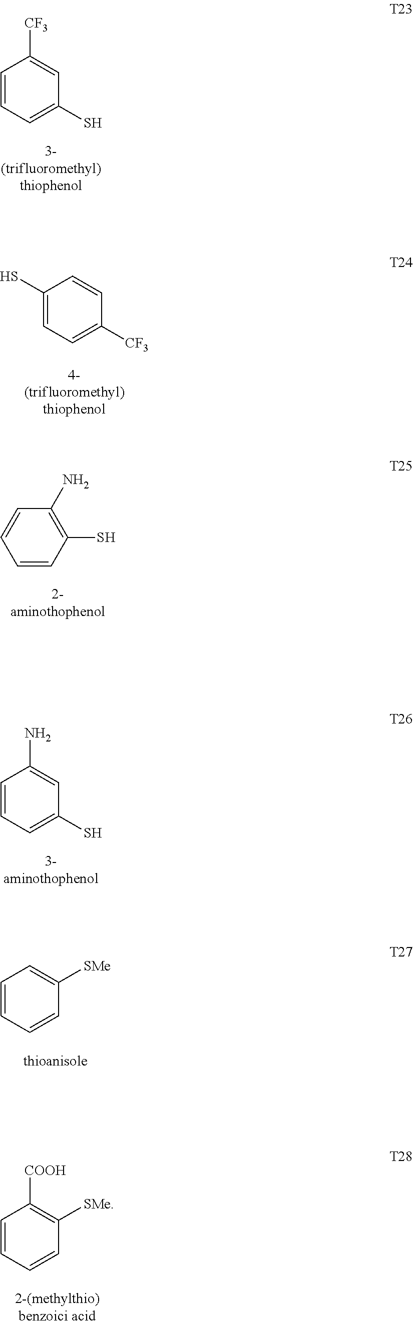 [SMILES: FC(F)(F)c1cccc(S)c1 ; FC(F)(F)c1ccc(S)cc1 ; Nc1ccccc1S ; Nc1cccc(S)c1 ; CSc1ccccc1 ; CSc1ccccc1C(=O)O]

7. The method of claim 1, wherein the substrate has the structure: 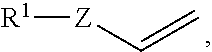
wherein:
Z is —O—, —CH₂—, —C(═O)—, —CH₂O—, —OCH₂—, —CH₂CH₂—, —CH₂C(═O)—, —C(═O)CH₂—, —OC(═O)—, —C(═O)O—, —N(R)CH₂—, —CH₂N(R)—, —C(═O)N(R)—; or —N(R)C(═O)—;
wherein R¹ is selected from the group consisting of C₁₋₂₀ alkyl, C₂₋₂₀ alkenyl, C₂₋₂₀ alkynyl C₁₋₂₀ heteroalkyl, C₃₋₂₀ cycloalkyl, C₃₋₂₀ heterocycloalkyl, C₁₋₂₀ alkyl-C₆₋₁₄ aryl, C₁₋₂₀ alkyl-C₆₋₁₄ heteroaryl, C₁₋₂₀ heteroalkyl-C₆₋₁₄ aryl, C₁₋₂₀ heteroalkyl-C₆₋₁₄ heteroaryl each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;
wherein each occurrence of R is independently hydrogen, C₁-C₁₀ alkyl, or C₆₋₁₀ aryl.

8. The method of claim 1, wherein the substrate comprises at least one thiol-containing monomer and at least one terminal alkene-containing monomer.

9. The method of claim 8, wherein the thiol-containing monomer comprises 2 to 6 thiol groups.

10. The method of claim 8, wherein the alkene-containing monomer comprises 2 terminal alkenes.

11. The method of claim 9, wherein the thiol-containing monomer is selected from the group consisting of: 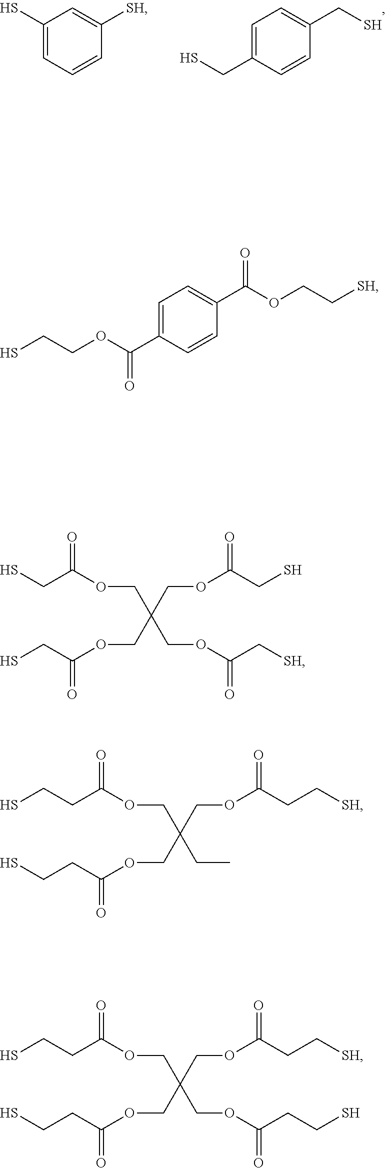 [SMILES: Sc1cccc(S)c1 ; SCc1ccc(CS)cc1 ; O=C(OCCS)c1ccc(C(=O)OCCS)cc1 ; O=C(CS)OCC(COC(=O)CS)(COC(=O)CS)COC(=O)CS ; CCC(COC(=O)CCS)(COC(=O)CCS)COC(=O)CCS ; O=C(CCS)OCC(COC(=O)CCS)(COC(=O)CCS)COC(=O)CCS] 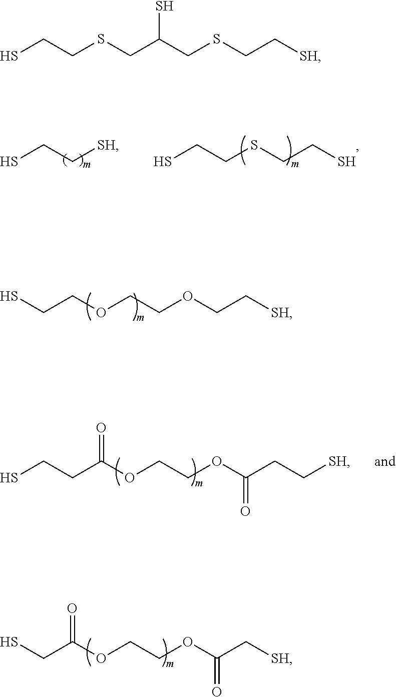
wherein each instance of m is independently an integer from 1 to 25.

12. The method of claim 10, wherein the alkene-containing monomer is selected from the group consisting of:

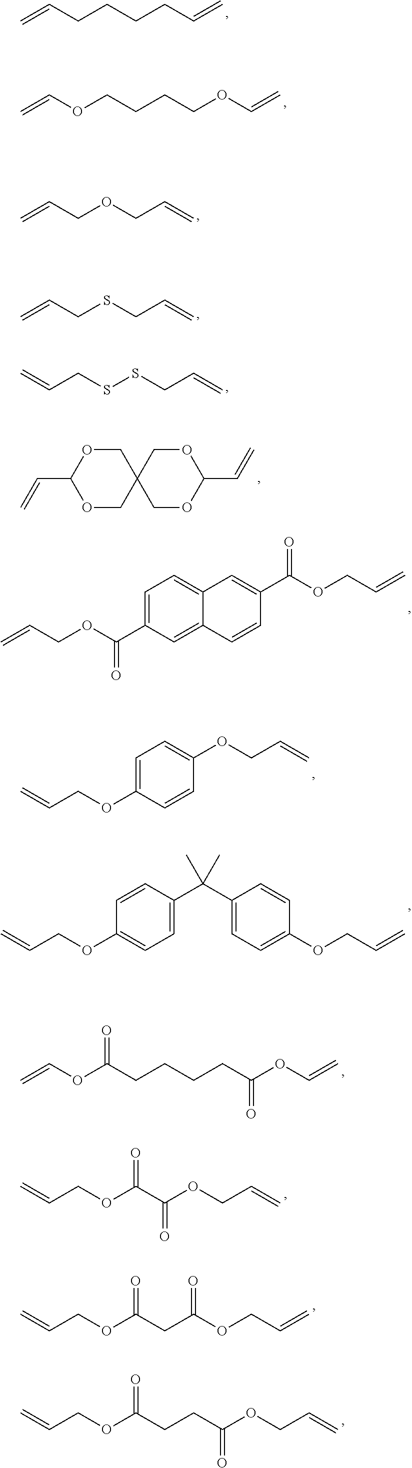

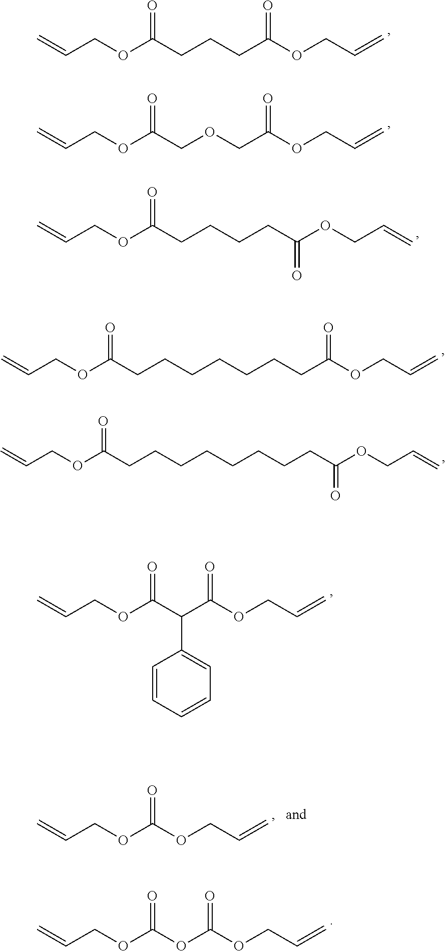

13. The method of claim 1, wherein the composition is irradiated with UV radiation having wavelength of about 380 nm to about 410 nm.

14. The method of claim 13, wherein the irradiation comprises light having intensity of about 1 mW/cm² to about 20 mW/cm².

15. The method of claim 7, wherein Z is —C(═O)—, —CH₂C(═O)—, —OC(═O)—, or —N(R)C(═O)—.

16. The method of claim 7, wherein Y is —O—, —OCH₂—, or —OC(═O).

17. The method of claim 7, wherein R¹ is C₁₋₂₀ alkyl.

18. A composition comprising:
at least one substrate comprising at least one polymerizable carbon-carbon double bond; and
a photoinitator comprising a compound of formula (I):
(Ar)ₙ—X—SH (I),
wherein:
Ar is optionally substituted C₆₋₁₈ aryl or optionally substituted C₆₋₁₈ heteroaryl, wherein the optional substitution is by 1 to 5 substituents independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;
X is a bond (absent) or C(═O) and n=1, or X is CH₃₋ₙ and n=1, 2, or 3; and
R at each occurrence is independently hydrogen, C₁-C₁₀ alkyl, or C₆₋₁₀ aryl.

19. The composition of claim 18, wherein the substrate has the structure: 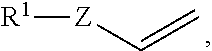
wherein:
Z is —O—, —CH₂—, —C(═O)—, —CH₂O—, —OCH₂—, —CH₂CH₂—, —CH₂C(═O)—, —C(═O)CH₂—, —OC(═O)—, —C(═O)O—, —N(R)CH₂—, —CH₂N(R)—, —C(═O)N(R)—; or —N(R)C(═O)—;
wherein R¹ is selected from the group consisting of C₁₋₂₀ alkyl, C₂₋₂₀ alkenyl, C₂₋₂₀ alkynyl C₁₋₂₀ heteroalkyl, C₃₋₂₀ cycloalkyl, C₃₋₂₀ heterocycloalkyl, C₁₋₂₀ alkyl-C₆₋₁₄ aryl, C₁₋₂₀ alkyl-C₆₋₁₄ heteroaryl, C₁₋₂₀ heteroalkyl-C₆₋₁₄ aryl, C₁₋₂₀ heteroalkyl-C₆₋₁₄ heteroaryl each of which is optionally substituted by 1 to 5 groups independently selected from the group consisting of F, Cl, Br, I, OR, OC(O)N(R)₂, CN, NO₂, CF₃, OCF₃, R, N(R)₂, SR, SOR, SO₂R, SO₂N(R)₂, SO₃R, C(O)R, C(O)C(O)R, C(O)CH₂C(O)R, C(O)OR, OC(O)R, C(O)N(R)₂, OC(O)N(R)₂, (CH₂)₀₋₂N(R)C(O)R, (CH₂)₁₋₂COOR, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(O)N(R)₂, N(COR)COR, N(OR)R, C(═NH)N(R)₂, C(O)N(OR)R, and C(═NOR)R;
wherein each occurrence of R is independently hydrogen, C₁-C₁₀ alkyl, or C₆₋₁₀ aryl.

20. The composition of claim 18, which is a polymerized composition.

21. (canceled)
